(19) United States
(12) Patent Application Publication
(10) Pub. No.: US 2023/0230016 A1
(43) Pub. Date: Jul. 20, 2023

(54) COORDINATING APPARATUS AND COORDINATION METHOD

(71) Applicant: Hitachi, Ltd., Tokyo (JP)

(72) Inventors: Junichi HIRAYAMA, Tokyo (JP); Yaemi TERAMOTO, Tokyo (JP); Toshihiro KUJIRAI, Tokyo (JP); Kohsei MATSUMOTO, Tokyo (JP); Naoki SHIMODE, Tokyo (JP)

(73) Assignee: Hitachi, Ltd., Tokyo (JP)

(21) Appl. No.: 18/009,635

(22) PCT Filed: Feb. 8, 2021
(86) PCT No.: PCT/JP2021/004591

§ 371 Date: Dec. 9, 2022

(30) Foreign Application Priority Data
Jun. 9, 2020 (JP) 2020-100121

(51) Int. Cl. G06Q 10/067; G06Q 10/04

(52) U.S. Cl. CPC G06Q 10/067; G06Q 10/04

(57) ABSTRACT

A coordinating apparatus selects discrete systems that simulate behavior of an actual environment and outputs an indicator value related to the actual environment, shares internal states related to the actual environments obtained on a basis of the behavior simulated by the discrete systems selected in the selection process, generates a shared internal state, decides such an action that a post-coordination integrated indicator value obtained by integrating a post-coordination indicator value from the discrete systems when the discrete systems are coordinated is optimized, the action being should be taken and being able to be taken by the discrete systems on a basis of the shared internal state in a case where the discrete systems are coordinated, determines whether or not the discrete systems should be coordinated on a basis of the post-coordination indicator values, and the indicator value from each of the discrete systems, and outputs a determination result.

### INCORPORATION BY REFERENCE

The present application claims the priority of Japanese Patent Application No. 2020-100121, which is a Japanese application filed on June 9, Reiwa 2 (2020), and the content of the patent application is incorporated herein by reference.

### TECHNICAL FIELD

The present invention relates to a coordinating apparatus and a coordination method that are used to coordinate a plurality of systems.

### BACKGROUND ART

As one of discrete virtual systems (hereinafter, discrete systems) that simulate, on computers, the behavior of actual environments like hospitals, fire stations, and factories, there is a cyber physical system (CPS: Cyber Physical System) that observes the state of an actual environment, decides an optimum action by performing a simulation in a discrete system, and presents the optimum action to the actual environment.

Patent Document 1 described below discloses a wide-area factory production management system. This wide-area factory production management system includes: an integrated virtual factory system formed by integrating a plurality of virtual factory systems corresponding to tangible factories at their respective locations; an integrated remote monitoring system that remotely monitors production past records of the tangible factories; an order-reception central control management system; a logistics central control monitoring system; and production planning means. Each virtual factory system includes simulating means for causing a virtual factory that data-models the tangible factory to perform simulated production, and examining its production situation. The production planning means generates a production plan for causing the tangible factories to share production, according to information obtained from the integrated virtual factory system and other individual systems.

### PRIOR ART DOCUMENT

### Patent Document

Patent Document 1: JP-2002-373191-A

### SUMMARY OF THE INVENTION

### Problem to be Solved by the Invention

However, the range of data that can be observed by discrete systems is limited in Patent Document 1 mentioned above, and there is a limitation on improvements of KPIs (an abbreviation for key performance indicators (Key Performance Indicators) of discrete systems.

An object of the present invention is to attempt to improve evaluation indicators that could not have been improved with discrete systems singly, and to realize overall optimization of a plurality of coordinated discrete systems.

### Means for Solving the Problem

A coordinating apparatus which is an aspect of the invention disclosed in the present application is a coordinating apparatus having a processor that executes a program, and a storage device that stores the program, in which the processor executes: a selection process of selecting a plurality of discrete systems from a group of discrete systems each of which simulates behavior of an actual environment, and outputs an indicator value related to the actual environment; a decision process of sharing each of internal states related to the actual environments, each of the internal states being obtained on the basis of the behavior simulated by each of the plurality of discrete systems selected in the selection process, generating a shared internal state, and, on the basis of the shared internal state, deciding such an action that a post-coordination integrated indicator value obtained by integrating a post-coordination indicator value from each of the plurality of discrete systems in a case where the plurality of discrete systems are coordinated is optimized, the action being should be taken and being able to be taken by each of the discrete systems in a case where the plurality of discrete systems are coordinated; a determination process of determining whether or not the plurality of discrete systems should be coordinated on the basis of the post-coordination indicator values, and the indicator value from each of the plurality of discrete systems; and an output process of outputting a result of the determination in the determination process.

### Advantages of the Invention

Representative embodiments of the present invention make it possible to improve evaluation indicators that could not have been improved with discrete systems singly, and to attempt to realize overall optimization of a plurality of coordinated discrete systems. Problems, configuration, and advantages other than those mentioned before will be made clear by explanations of embodiments below.

### BRIEF DESCRIPTION OF THE DRAWINGS

FIG. 1 is a block diagram depicting a configuration example of discrete systems according to a first embodiment.

FIG. 2 is an explanatory diagram depicting an ambulance-system simulation example 1.

FIG. 3 is an explanatory diagram depicting an ambulance-system simulation example 2.

FIG. 4 is an explanatory diagram depicting an ambulance-system simulation example 3.

FIG. 5 is an explanatory diagram depicting an example of the internal state of a simulator in the simulation examples 1 to 3 in FIG. 2 to FIG. 4.

FIG. 6 is an explanatory diagram depicting an example of an action of the simulator in the simulation examples 1 to 3 in FIG. 2 to FIG. 4.

FIG. 7 is an explanatory diagram depicting an example of a KPI computation result of the simulator in the simulation examples 1 to 3 in FIG. 2 to FIG. 4.

FIG. 8 is an explanatory diagram depicting a hospital-system simulation example 1.

FIG. 9 is an explanatory diagram depicting a hospital-system simulation example 2.

FIG. 10 is an explanatory diagram depicting a hospital-system simulation example 3.

FIG. 11 is an explanatory diagram depicting a hospital-system simulation example 4.

FIG. 12 is an explanatory diagram depicting an example of the internal state of the simulator in the simulation examples 1 to 4 in FIG. 8 to FIG. 11.

FIG. 13 is an explanatory diagram depicting an example of an action of the simulator in the simulation examples 1 to 4 in FIG. 8 to FIG. 11.

FIG. 14 is an explanatory diagram depicting an example of a KPI computation result of the simulator in the simulation examples 1 to 4 in FIG. 8 to FIG. 11.

FIG. 15 is a block diagram depicting a configuration example of a coordination system according to the first embodiment.

FIG. 16 is an explanatory diagram depicting a system configuration example of the coordination system.

FIG. 17 is a block diagram depicting a hardware configuration example of a computer (a coordinating apparatus and discrete systems).

FIG. 18 is an explanatory diagram depicting an example 1 of pre-evaluation by a pre-evaluating section.

FIG. 19 is an explanatory diagram depicting an example 2 of pre-evaluation by the pre-evaluating section.

FIG. 20 is an explanatory diagram depicting an example 3 of pre-evaluation by the pre-evaluating section.

FIG. 21 is an explanatory diagram depicting an example 4 of pre-evaluation by the pre-evaluating section.

FIG. 22 is an explanatory diagram depicting an example of a shared internal state of simulators in the simulation examples 1 to 3 in FIG. 18 to FIG. 21.

FIG. 23 is an explanatory diagram depicting an example of an integrated action of the simulators in the simulation examples 1 to 3 in FIG. 18 to FIG. 21.

FIG. 24 is an explanatory diagram depicting an example of a pre-coordination integrated KPI computation result of the simulators in the simulation examples 1 to 3 in FIG. 18 to FIG. 21.

FIG. 25 is an explanatory diagram depicting an example of a post-coordination integrated KPI computation result of the simulators in the simulation examples 1 to 3 in FIG. 18 to FIG. 21.

FIG. 26 is an explanatory diagram depicting an example of a post-coordination KPI computation result of the simulator of an ambulance system in the pre-evaluation examples 1 to 3 in FIG. 18 to FIG. 21.

FIG. 27 is an explanatory diagram depicting an example of a post-coordination KPI computation result of the simulator of a hospital system in the simulation examples 1 to 3 FIG. 18 to FIG. 21.

FIG. 28 is an explanatory diagram depicting an example of an integrated KPI list.

FIG. 29 is an explanatory diagram depicting an example of a system coordination comparison perspective.

FIG. 30 is an explanatory diagram depicting an example of a determination process by a determining section.

FIG. 31 is a flowchart depicting an example of a process procedure of coordinating a plurality of discrete systems by the coordinating apparatus according to the first embodiment.

FIG. 32 is a block diagram depicting an example of operation by an integrated system after coordination.

FIG. 33 is a block diagram depicting a configuration example of the ambulance system.

FIG. 34 is a block diagram depicting a configuration example of the hospital system.

FIG. 35 is a block diagram depicting an example 1 of connection between discrete systems in the integrated system.

FIG. 36 is a block diagram depicting an example 2 of connection between discrete systems in the integrated system.

FIG. 37 is an explanatory diagram depicting an example of a connection specifying information management table.

FIG. 38 is a flowchart depicting an example of the process procedure of coordinating a plurality of discrete systems by the coordinating apparatus according to a second embodiment.

FIG. 39 is a block diagram depicting a configuration example of discrete systems according to a third embodiment.

FIG. 40 is a graph depicting an example 1 of monitoring by a KPI monitoring section and a state error monitoring section.

FIG. 41 is a graph depicting an example 2 of monitoring by the KPI monitoring section and the state error monitoring section.

FIG. 42 is an explanatory diagram depicting an example of selection of coordination subjects by a selecting section according to the third embodiment.

### MODES FOR CARRYING OUT THE INVENTION

### First Embodiment

<Discrete Systems>

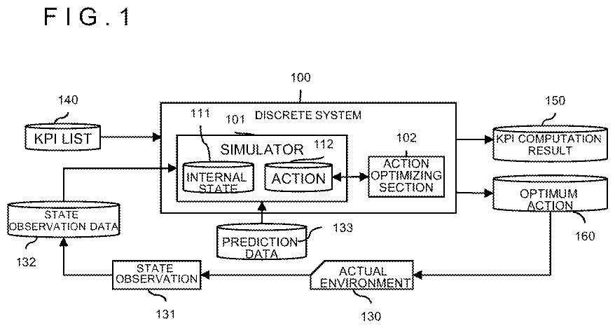

FIG. 1 is a block diagram depicting a configuration example of discrete systems according to a first embodiment. A discrete system 100 is a discrete virtual system that simulates, on a computer, the behavior of an actual environment 130. Specifically, for example, the discrete system 100 is a CPS that analyzes the behavior of the actual environment 130 in a case where state observation data 132 obtained by state observation 131 or prediction data 133 is input from the actual environment 130, and outputs a KPI computation result 150 about types of KPI specified on a KPI list 140, outputs an optimum action 160, and so on.

The actual environment 130 is an actual environment which is treated as a subject of analysis. For example, in a case where the discrete system 100 is an ambulance system that allocates ambulances, the actual environment 130 is a fire station having the ambulances. In addition, in a case where the discrete system 100 is a hospital system that manages the number of accommodatable patients and number of available ICUs (an abbreviation for intensive care units (Intensive Care Units) of a hospital, the actual environment 130 is a hospital.

In the state observation 131, the state of the actual environment 130 is observed, and results of the observation are input as the state observation data 132 to the discrete system 100. The state observation 131 may be performed by a computer inside or outside the discrete system 100, or may be performed by a user who manages the actual environment 130. In a case where the actual environment 130 is an ambulance system, the state observation data 132 includes the number of waiting ambulances and number of dispatched ambulances at an observation date/time, information about a dispatch-requester patient, and information about a position to which an ambulance is dispatched, for example. In a case where the actual environment 130 is a hospital system, the state observation data 132 includes the number of accommodatable patients and number of available ICUs at an observation date/time, for example. In addition, the prediction data 133 is state observation data 132 of past particular dates or days of the week.

The KPI list 140 is list data specifying types of KPI treated as the output subjects of the discrete system 100. For example, in a case where the discrete system 100 is an ambulance system, the KPI list 140 includes, as a type of KPI, average transport time of ambulances of all subject fire stations. Transport time is a length of time from when an ambulance departs from a fire station until when the ambulance completes transportation of a patient to a specified hospital after the patient is carried into the ambulance.

In addition, in a case where the discrete system 100 is a hospital system, the KPI list 140 includes average treatment time of patients of all subject hospitals. Treatment time is a length of time from when a patient arrives at a hospital until when treatment of the patient is completed. Treatment is a medical activity of a doctor to treat an injury and illness, and includes, for example, an injury-related process on a wound or an external injury, a burn-related process when a patient has a burn, artificial respiration, a gastric lavage, and the like.

The KPI computation result 150 is a value of a type of KPI specified on the KPI list 140 in a case where the state observation data 132 or the prediction data 133 is input. For example, where the actual environment 130 is an ambulance system, a KPI is average transport time, and where the actual environment 130 is a hospital system, a KPI is average treatment time.

The optimum action 160 is an optimum action that can be adopted in the actual environment 130. Where the discrete system 100 is an ambulance system, for example, the optimum action 160 is a hospital that is closest to the position of a patient, and where the discrete system 100 is a hospital system, the optimum action 160 is a hospital that can accommodate a patient and additionally has an available ICU.

The discrete system 100 has a simulator 101 and an action optimizing section 102. The simulator 101 retains internal states 111 representing values of states in the simulator 101, and actions 112 each of which is set as an action to be taken when a certain internal state 111 is observed, and the simulator 101 outputs the KPI computation result 150. The action optimizing section 102 decides the optimum action 160 for an internal state 111 at a certain observation date/time from the actions 112 that can be adopted by the simulator 101, such that a KPI is maximized.

The simulator 101 and the action optimizing section 102 can be realized by using reinforcement learning, for example. Specifically, for example, in reinforcement learning, states s are internal states 111, actions a are actions 112, and rewards r are KPIs that are obtained when the simulator 101 is executed for a predetermined period (e.g. one day).

<Ambulance-System Simulation Examples>

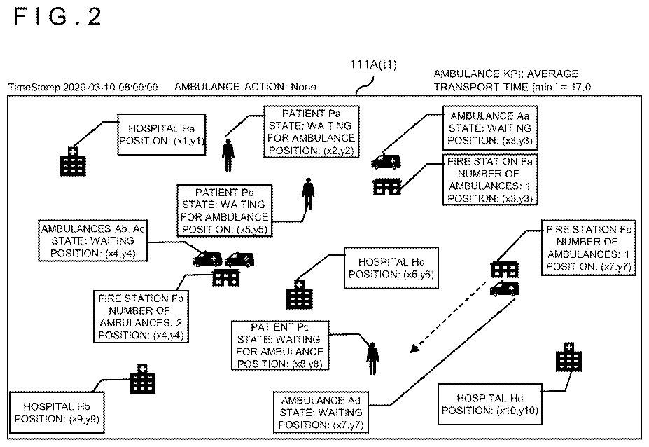

Next, examples of simulation by the simulator 101 in a case where the discrete system 100 is an ambulance system are explained in a time-series by using FIG. 2 to FIG. 4. In the following figures, hospitals Ha to Hd, fire stations Fa to Fc, ambulances Aa to Ad and patients Pa to Pc appear, and in a case where distinctions are not made among the hospitals Ha to Hd, among the fire stations Fa to Fc, among the ambulances Aa to Ad, or among the patients Pa to Pc, they are denoted as hospitals H, fire stations F, ambulances A, and patients P, respectively.

FIG. 2 is an explanatory diagram depicting an ambulance-system simulation example 1. The simulation example 1 in FIG. 2 depicts an internal state 111A(t1) at an observation date/time t1=Mar. 10, 2020, 8:00. The internal state 111A(t1) includes the positions of the hospitals H, the positions and numbers of waiting ambulances of the fire stations F, the states and positions of the ambulances A, and the states and positions of the patients P. The positions of the hospitals H and the positions of the fire stations F are invariable information, and therefore, are set in advance. On the other hand, the numbers of ambulances waiting at the fire stations F, the states and positions of the ambulances A, and the states and positions of the patients P are variable information, and therefore, are acquired as the state observation data 132.

In the simulation examples 1 to 3 in FIG. 2 to FIG. 4, a KPI (ambulance KPI) of the ambulance system is average transport time. It is supposed here that since there is the patient Pc at the observation date/time t1, the fire station Fc that is closest to the patient Pc and additionally has the number of waiting ambulances which is “1” receives a request for transportation of the patient Pc to a hospital, and the ambulance Ad leaves for the patient Pc.

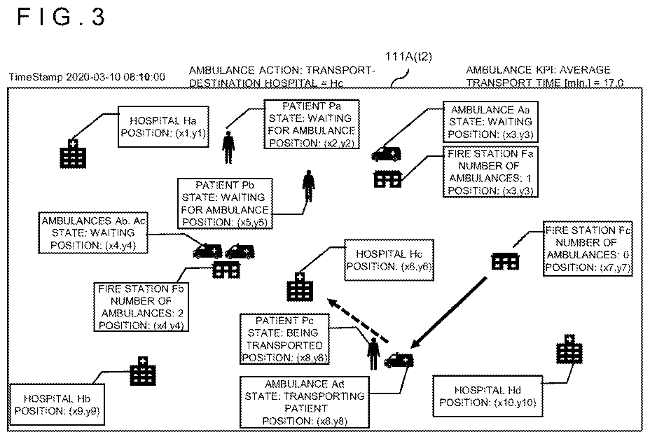

FIG. 3 is an explanatory diagram depicting an ambulance-system simulation example 2. The simulation example 2 in FIG. 3 depicts an internal state 111A(t2) in a case where an observation date/time t2 is Mar. 10, 2020, 8:10, which is ten minutes after the observation date/time t1. The internal state 111A(t2) represents a state where, according to the state observation data 132 at the observation date/time t2, the ambulance Ad of the fire station Fc arrives at the patient Pc, and transportation to the hospital Hc is started. Since the ambulance Ad has arrived at the patient Pc at the observation date/time t2, the simulator 101 decides a transport-destination hospital from the hospitals Ha to Hd. For example, it is supposed that the simulator 101 decides, as the transport-destination hospital, the hospital Hc with which the Q-value of an action-value function becomes the highest, according to reinforcement learning. The decided transport-destination hospital Hc becomes an action (ambulance action) 112 of the ambulance system.

In addition, since the ambulance Ad has been dispatched from the fire station Fc, the number of ambulances of the fire station Fc is updated from “1” to “0.” In addition, since the ambulance Ad has started the transportation of the patient Pc, the state and position of the ambulance Ad are updated to “transporting patient” and to the same position (x8, x8) as the patient Pc, respectively, at the observation date/time t2. In addition, since the patient Pc is transported by the ambulance Ad, the state of the patient Pc is updated from “waiting” to “being transported” at the observation date/time t2.

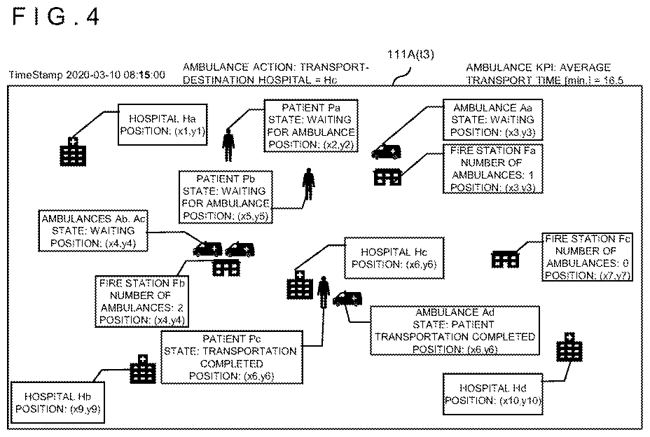

FIG. 4 is an explanatory diagram depicting an ambulance-system simulation example 3. The simulation example 3 in FIG. 4 depicts an internal state 111A(t3) in a case where an observation date/time t3 is Mar. 10, 2020, 8:15, which is five minutes after the observation date/time t2. The internal state 111A(t3) represents a state where, according to the state observation data 132 at the observation date/time t3, the ambulance Ad onto which the patient Pc is carried at the position (x8, y8) transports the patient Pc to and arrives at the transport-destination hospital Hc.

In addition, since the ambulance Ad has arrived at the transport-destination hospital Hc, the state and position of the ambulance Ad are updated from “transporting patient” to “patient transportation completed” and to the same position (x6, x6) as the transport-destination hospital Hc, respectively, at the observation date/time t3. In addition, since the patient Pc also has arrived at the transport-destination hospital Hc, the state and position of the patient Pc are updated from “being transported” to “transportation completed” and to the same position (x6, x6) as the transport-destination hospital Hc, respectively, at the observation date/time t3.

Using, as transport time, a length of time from the date/time t1 when the ambulance Ad is dispatched from the fire station Fc until the date/time t3 when the ambulance Ad arrives at the transport-destination hospital Hc, the simulator 101 recomputes the average transport time, which is an ambulance KPI, and updates the average transport time from 17.0 [minutes] to 16.5 [minutes].

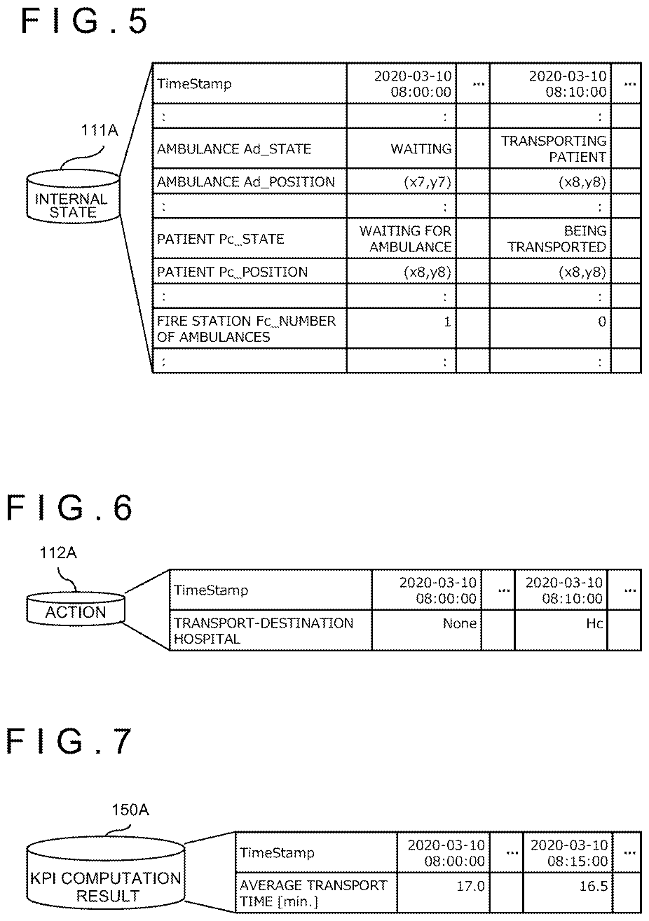

FIG. 5 is an explanatory diagram depicting an example of the internal state 111A of the simulator 101 in the simulation examples 1 to 3 in FIG. 2 to FIG. 4. FIG. 6 is an explanatory diagram depicting an example of an action 112A of the simulator 101 in the simulation examples 1 to 3 in FIG. 2 to FIG. 4. FIG. 7 is an explanatory diagram depicting an example of a KPI computation result 150A of the simulator 101 in the simulation examples 1 to 3 in FIG. 2 to FIG. 4.

<Hospital-System Simulation Examples>

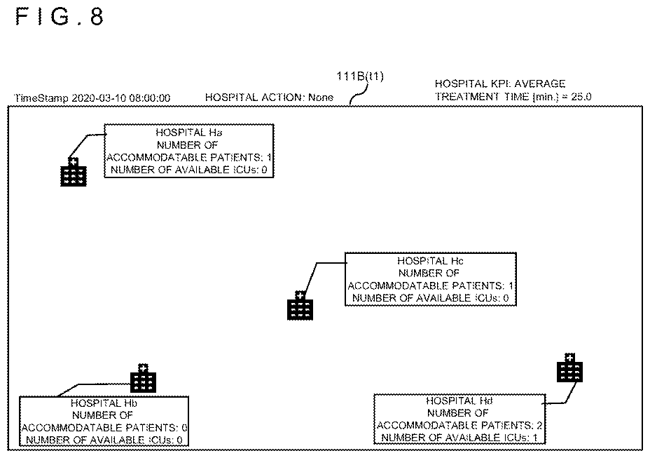

Next, examples of simulation by the simulator 101 in a case where the discrete system 100 is a hospital system are explained in a time-series by using FIG. 8 to FIG. 11.

FIG. 8 is an explanatory diagram depicting a hospital-system simulation example 1. The simulation example 1 in FIG. 8 depicts an internal state 111B(t1) at the observation date/time t1=Mar. 10, 2020, 8:00. The internal state 111B(t1) includes the number of accommodatable patients and number of available ICUs of the hospitals H. The numbers of accommodatable patients and numbers of available ICUs of the hospitals H are variable information, and are acquired as the state observation data 132. In the simulation examples 1 to 4 in FIG. 8 to FIG. 11, a KPI of the hospital system is average treatment time. At the observation date/time t1, the average treatment time is 25.0 [minutes].

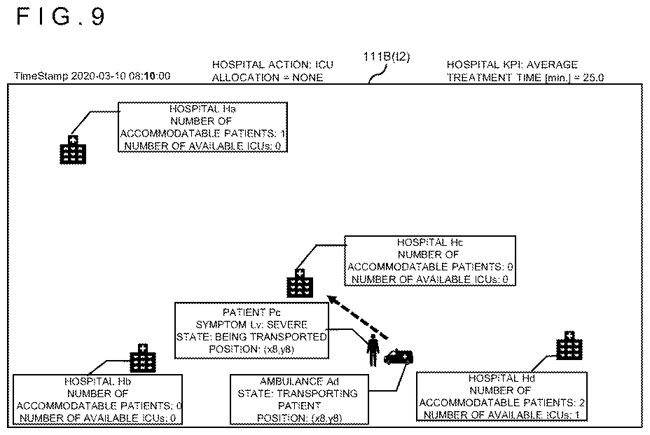

FIG. 9 is an explanatory diagram depicting a hospital-system simulation example 2. The simulation example 2 in FIG. 9 depicts an internal state 111B(t2) in a case where the observation date/time t2 is Mar. 10, 2020, 8:10, which is ten minutes after the observation date/time t1. The internal state 111B(t2) includes the numbers of accommodatable patients and numbers of available ICUs of the hospitals H, the states and positions of the ambulances A, and the symptom levels, states, and positions of the patients P. The states and positions of the ambulances A, and the symptom levels, states, and positions of the patients P are variable information, and are acquired as the state observation data 132.

Here, since there are the patient Pc and the ambulance Ad that transports the patient Pc to the hospital Hc at the position (x8, y8) at the observation date/time t2, the number of accommodatable patients of the hospital Hc is updated from “1” to “0.” However, since the number of available ICUs of the transport-destination hospital Hc is “0,” the simulator 101 decides “ICU allocation=None” as an action (hospital action) 112 of the hospital system regarding the patient Pc.

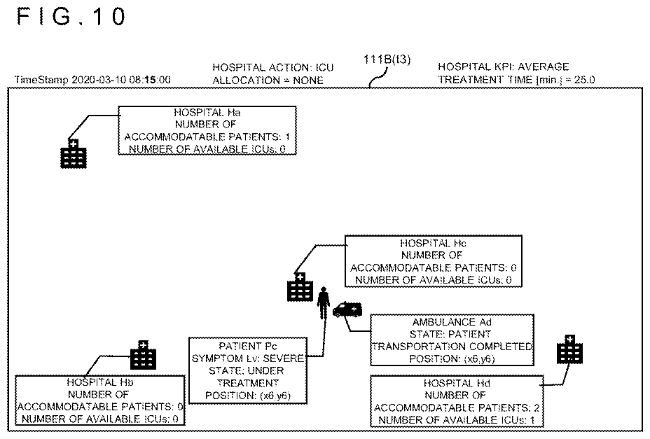

FIG. 10 is an explanatory diagram depicting a hospital-system simulation example 3. The simulation example 3 in FIG. 10 depicts an internal state 111B(t3) in a case where the observation date/time t3 is Mar. 10, 2020, 8:15, which is five minutes after the observation date/time t2. The internal state 111B(t3) represents a state where, according to the state observation data 132 at the observation date/time t3, the ambulance Ad onto which the patient Pc is carried at the position (x8, y8) transports the patient Pc to and arrives at the transport-destination hospital Hc, and treatment is started.

In addition, since the ambulance Ad has arrived at the transport-destination hospital Hc, the state and position of the ambulance Ad are updated from “transporting patient” to “patient transportation completed” and to the position (x6, x6), respectively, at the observation date/time t3. In addition, since the patient Pc also has arrived at the transport-destination hospital. Hc, the state and position of the patient Pc are updated from “being transported” to “under treatment” and to the same position (x6, x6) as the transport-destination hospital Mc, respectively, at the observation date/time t3.

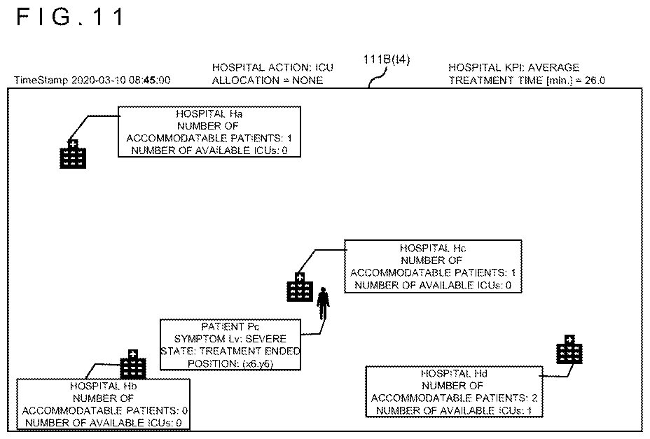

FIG. 11 is an explanatory diagram depicting a hospital-system simulation example 4. The simulation example 4 in FIG. 11 depicts an internal state 111B(t4) in a case where an observation date/time t4 is Mar. 10, 2020, 8:45, which is 30 minutes after the observation date/time t3. The internal state 111B(t4) represents a state where, according to the state observation data 132 at the observation date/time t4, the treatment of the patient Pc at the transport-destination hospital Hc is ended.

In addition, since the treatment of the patient Pc has been ended, the state of the patient Pc is updated from “under treatment” to “treatment ended,” and the number of accommodatable patients of the hospital Hc is updated from “0” to “1.”

Using, as treatment time, a length of time from the observation date/time t3 when the treatment of the patient Pc is started at the transport-destination hospital Hc until the observation date/time t4 when the treatment is ended, the simulator 101 recomputes the average treatment time, which is a hospital KPI, and updates the average treatment time from 25.0 [minutes] to 26.0 [minutes].

FIG. 12 is an explanatory diagram depicting an example of the internal state 111B of the simulator 101 in the simulation examples 1 to 4 in FIG. 8 to FIG. 11. FIG. 1.3 is an explanatory diagram depicting an example of an action 112B of the simulator 101 in the simulation examples 1 to 4 in FIG. 8 to FIG. 11. FIG. 14 is an explanatory diagram depicting an example of a KPI computation result 150B of the simulator 101 in the simulation examples 1 to 4 in FIG. 8 to FIG. 11.

<Configuration Example of Coordinating Apparatus>

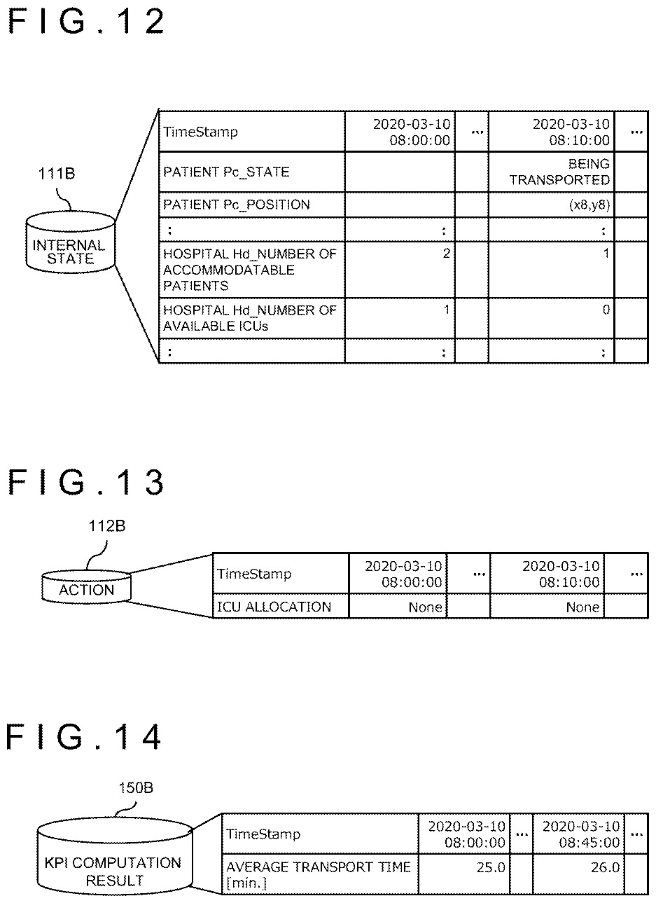

If the discrete system 100 depicted in FIG. 1 to FIG. 14 is used singly, the range of the state observation data 132 is limited, and there is a limitation on improvements of KPIs. For example, since the ambulance system does not use the state observation data 132 used in the hospital system like the numbers of accommodatable patients and numbers of available ICUs of the hospitals H and the symptom levels of the patients P, the ambulance system undesirably simulates transportation of the patient Pc to, as an optimum transport destination, the hospital Hc that has no available ICUs.

Similarly, since the hospital system does not use the state observation data 132 used in the ambulance system like the positions and numbers of ambulances of the fire stations F and the states of the ambulances A until the patients P are carried, the hospital system cannot decide the transport destinations of the patients P, and thus undesirably simulates treatment of a patient P with a “severe” symptom level at the hospital Hc with the number of available ICUs which is “0.” In view of this, a coordinating apparatus according to the first embodiment coordinates a plurality of discrete systems 100, the plurality of discrete systems 100 are coordinated to generate an integrated system, and it is attempted to enhance KPIs of the integrated system.

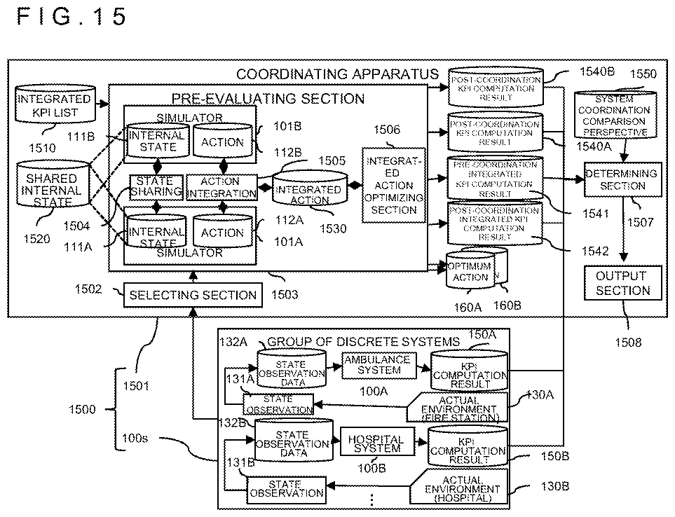

FIG. 15 is a block diagram depicting a configuration example of the coordination system according to the first embodiment. A coordination system 1500 includes a coordinating apparatus 1501, and a group 100s of discrete systems including a plurality of discrete systems 100. The coordinating apparatus 1501 manages the group 100s of discrete systems.

The group 100s of discrete systems is a set of discrete systems 100 like an ambulance system 100A, a hospital system 100B, . . . , for example. Note that elements with reference characters which are given A at their ends are elements related to the ambulance system 100A, and elements with reference characters which are given B at their ends are elements related to the hospital system 100B. For example, an actual environment 130A is an actual environment 130 related to the ambulance system 100A, that is, a fire station, and the KPI computation result 150A is a KPI computation result output from the ambulance system 100A.

The coordinating apparatus 1501 has a selecting section 1502, a pre-evaluating section 1503, a determining section 1507, and an output section 1508. The selecting section 1502 selects, as coordination subjects, a set of two or more discrete systems 100, and passes the selection result to the pre-evaluating section 1503. As a selection method, the selecting section 1502 may perform the selection randomly or may select a set of two or more discrete systems 100 that are selected by an external section.

The pre-evaluating section 1503 executes a pre-evaluation of a case where the coordination subjects selected by the selecting section 1502 are coordinated. It is supposed here that the ambulance system 100A and the hospital system 100B are selected as the coordination subjects. The pre-evaluating section 1503 has simulators 101A and 101B of the respective coordination-subject discrete systems 100, a state sharing section 1504, an action integrating section 1505, and an integrated action optimizing section 1506.

The pre-evaluating section 1503 executes the pre-evaluation by coordinating the simulators 101A and 101B of the discrete systems 100 selected as the coordination subjects by the selecting section 1502. For example, the simulators 101A and 101B in the pre-evaluating section 1503 may be realized as physical machines in the coordinating apparatus 1501 or may be realized as virtual machines.

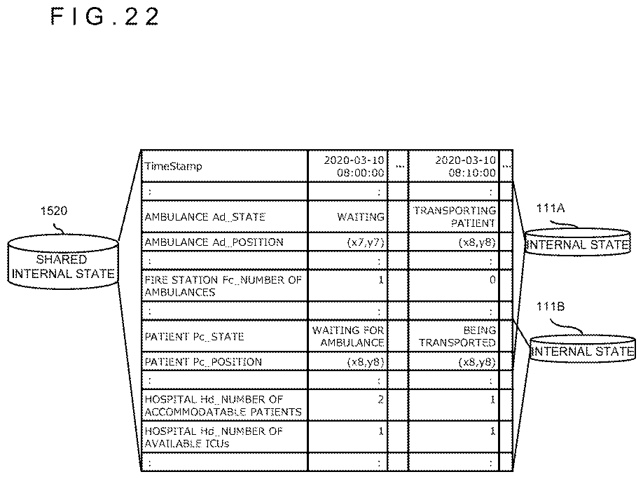

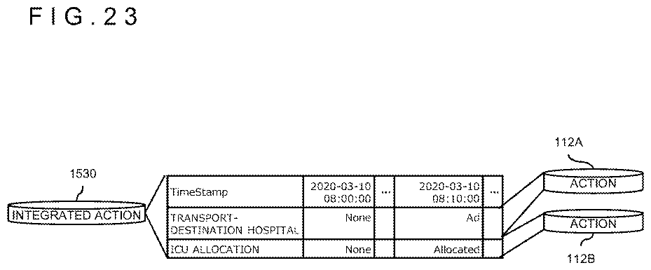

The state sharing section 1504 causes the internal states 111A and 111B in the simulators 101A and 101B to be shared, and generates a shared internal state 1520. Details of the shared internal state 1520 are mentioned later in FIG. 22. The action integrating section 1505 integrates the actions 112A and 112B in the simulators 101A and 101B, and generates an integrated action 1530. Details of the integrated action 1530 are mentioned later in FIG. 23.

The integrated action optimizing section 1506 refers to an integrated KPI list 1510, computes various types of KPI regarding a plurality of the coordinated discrete systems 100 (the ambulance system 100A and the hospital system 100B), and outputs the KPIs as post-coordination KPI computation results 1540A and 1540B, a pre-coordination integrated KPI computation result 1541, and a post-coordination integrated KPI computation result 1542. The integrated action optimizing section 1506 decides optimum actions 160A and 160B for the internal state 111 at a certain observation date/time from the actions 112A and 112B that can be adopted by the simulators 101A and 101B, such that the post-coordination integrated KPI computation result 1542 is maximized.

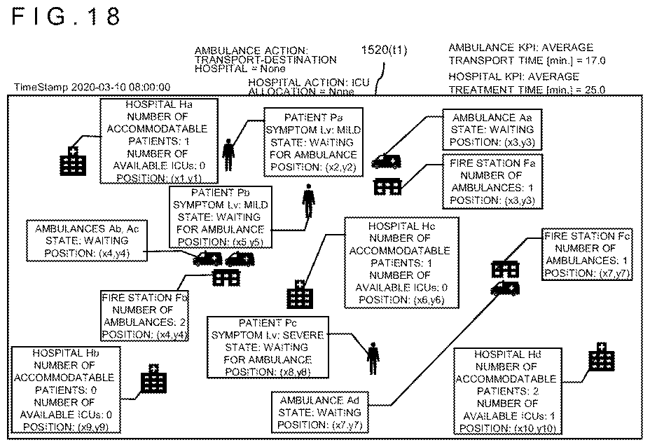

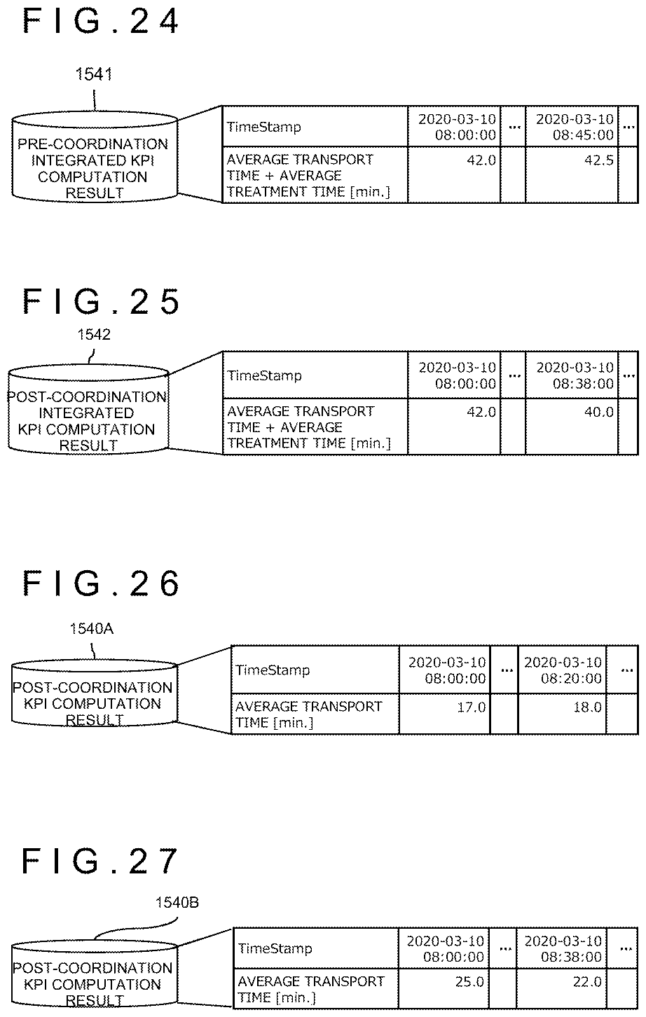

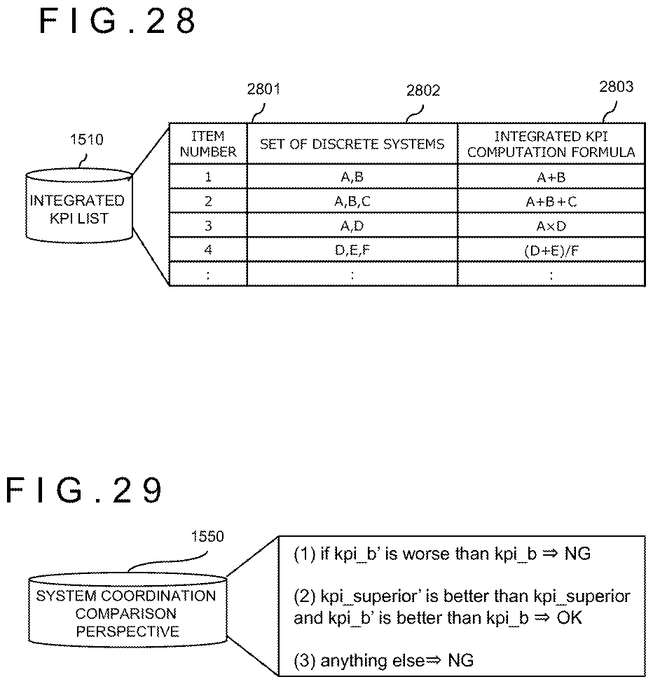

Details of the pre-coordination integrated KPI computation result 1541, the post-coordination integrated KPI computation result 1542, and the post-coordination KPI computation results 1540A and 1540B are mentioned later in FIG. 24 to FIG. 27. Details of the integrated KPI list 1510 are mentioned later in FIG. 28. Optimization (e.g. reinforcement learning) by the integrated action optimizing section 1506 using the shared internal state 1520 and the integrated action 1530 is mentioned later in FIG. 18 to FIG. 21.

The determining section 1507 receives input of the post-coordination KPI computation results 1540A and 1540B, the pre-coordination integrated KPI computation result 1541, and the post-coordination integrated KPI computation result 1542, determines whether or not the integrated system after coordination of the ambulance system 100A and the hospital system 100B is favorable on the basis of a system coordination comparison perspective 1550, and outputs the determination result. Details of the system coordination comparison perspective 1550 are mentioned later in FIG. 29.

The output section 1508 outputs, as a coordination plan, optimum coordination subjects (e.g. a set of the ambulance system 100A and the hospital system 100B) from a result of a determination about each coordination subject. Specifically, for example, the output section 1508 displays the coordination plan on a display, transmits the coordination plan to another computer, and so on.

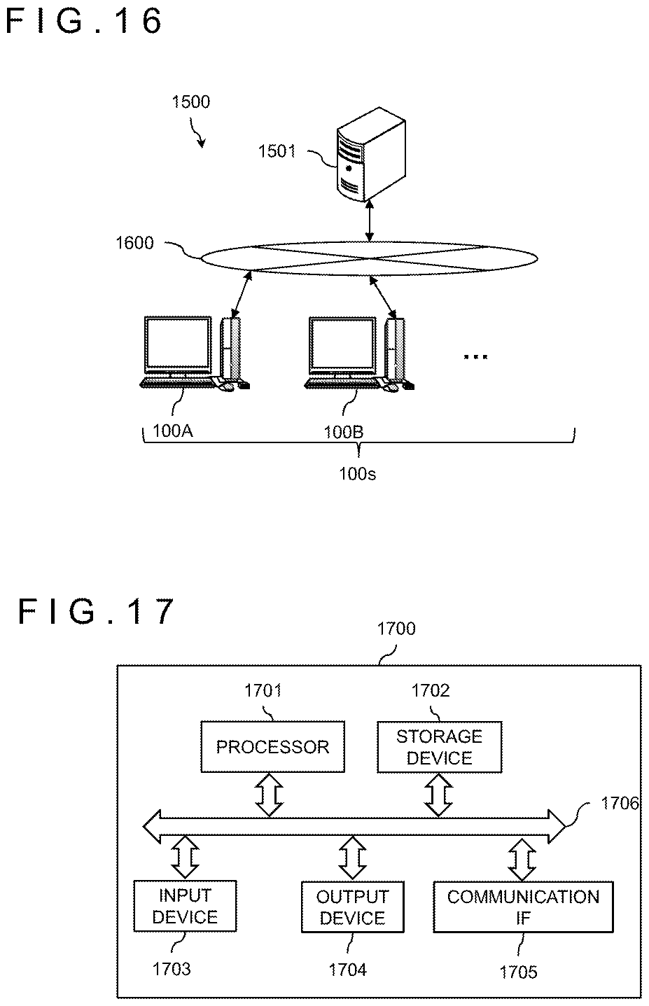

FIG. 16 is an explanatory diagram depicting a system configuration example of the coordination system 1500. The coordination system 1500 has configuration in which the coordinating apparatus 1501 and the group 100s of discrete systems are connected communicatively with each other via a network 1600 such as a LAN (Local Area Network), a WAN (Wide Area Network), or the Internet.

<Hardware Configuration Example of Computer>

FIG. 17 is a block diagram depicting a hardware configuration example of a computer (the coordinating apparatus 1501 and the discrete system 100). A computer 1700 has a processor 1701, a storage device 1702, an input device 1703, an output device 1704, and a communication interface (communication IF) 1705. The processor 1701, the storage device 1702, the input device 1703, the output device 1704, and the communication IF 1705 are connected with each other by a bus 1706. The processor 1701 controls the computer 1700. The storage device 1702 serves as a work area of the processor 1701. In addition, the storage device 1702 is a non-transitory or transitory recording medium that stores various types of program or data. The storage device 1702 include a ROM (Read Only Memory), a RAM (Random Access Memory), an HDD (Hard Disk Drive), and a flash memory, for example. The input device 1703 is used to input data. The input device 1703 include a keyboard, a mouse, a touch panel, a numeric keypad, and a scanner, for example. The output device 1704 is used to output data. The output device 1704 include a display, a printer, and a speaker, for example. The communication IF 1705 is connected to a network, and transmits and receives data.

Specifically, the selecting section 1502, pre-evaluating section 1503, determining section 1507, and output section 1508 mentioned above are realized by causing the processor 1701 to execute a program stored on the storage device 1702, for example.

<Examples of Pre-Evaluation by Pre-Evaluating Section 1503>

Next, examples of pre-evaluation of coordination of the ambulance system 100A and the hospital system 100B by the pre-evaluating section 1503 are explained in a time-series by using FIG. 18 to FIG. 21.

FIG. 18 is an explanatory diagram depicting an example 1 of pre-evaluation by the pre-evaluating section 1503. The pre-evaluation example 1 in FIG. 18 represents a shared internal state 1520(t1) at the observation date/time t1=Mar. 10, 2020, 8:00. The shared internal state 1520(t1) is information including the shared internal state 111A(t1) and internal state 111B(t1) at the observation date/time t1. An integrated KPI obtained by pre-evaluation of coordination of the ambulance system 100A and the hospital system 100B is the sum of an ambulance KPI and a hospital KPI, for example. The formula for computing the integrated KPI is decided by the integrated KPI list 1510. It is supposed here that since there is the patient Pc at the observation date/time t1, the fire station Fc that is closest to the patient Pc and additionally has the number of waiting ambulances which is “1” receives a request for transportation of the patient Pc to a hospital, and the ambulance Ad leaves for the patient Pc.

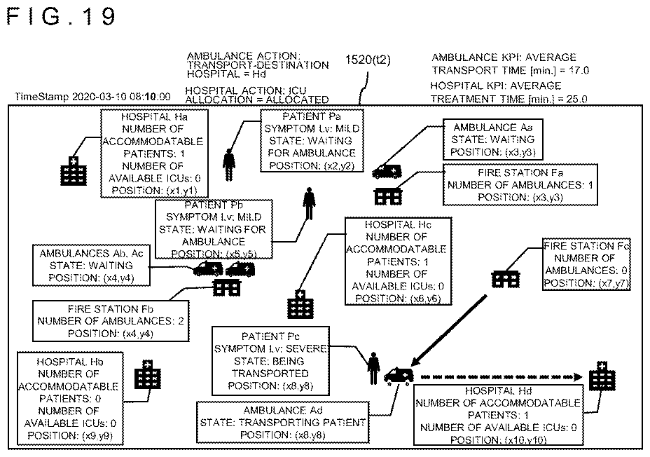

FIG. 19 is an explanatory diagram depicting an example 2 of pre-evaluation by the pre-evaluating section 1503. The pre-evaluation example 2 in FIG. 19 represents a shared internal state 1520(t2) in a case where the observation date/time t2 is Mar. 10, 2020, 8:10, which is ten minutes after the observation date/time t1. At the observation date/time t2, the simulator 101A of the ambulance system 100A refers to the shared internal state 1520(t2), and decides a transport-destination hospital H from the hospitals Ha to Hd from the perspective of minimizing the integrated KPI (=(average transport time)+(average treatment time)), and the simulator 101B of the hospital system 100B decides ICU allocation from the perspective of minimizing the integrated KPI (=(average transport time)+(average treatment time)).

For example, by reinforcement learning, the simulator 101A of the ambulance system 100A decides, as the transport-destination hospital, the hospital Hd with which the Q-value of an action-value function becomes the highest from the perspective of minimizing the integrated KPI (=(average transport time)+(average treatment time)). The decided transport-destination hospital Hd becomes an action (ambulance action) 112A of the ambulance system 100A. That is, in a case where only the ambulance KPI (average transport time) is taken into consideration, the hospital Hc closest to the patient Pc is decided as the transport-destination hospital, but since the hospital KPI (average treatment time) also needs to be taken into consideration, the hospital Hd closest to the patient Pc is decided as the transport-destination hospital from hospitals whose numbers of accommodatable patients are equal to or greater than “1” and additionally whose numbers of available ICUs are equal to or greater than “1.”

In addition, since the ambulance Ad has been dispatched from the fire station Fc, the number of ambulances of the fire station Fc is updated from “1” to “0.” In addition, since the ambulance Ad has started the transportation of the patient Pc, the state and position of the ambulance Ad are updated to “transporting patient” and to the same position (x8, x8) as the patient Pc, respectively, at the observation date/time t2. In addition, since the patient Pc is transported by the ambulance Ad, the state of the patient Pc is updated from “waiting” to “being transported” at the observation date/time t2.

In addition, since the transport-destination hospital H is decided as the hospital Hd by the simulator 101A of the ambulance system 100A, the simulator 101 of the hospital system 100B refers to the number of available ICUs of the hospital Hd, and decides an action (hospital action) 112B of the hospital system 100B for the patient Pc as “ICU allocation=Allocated.” Accordingly, at the observation date/time t2, the number of accommodatable patients of the hospital Hd is updated from “2” to “1,” and the number of available ICUs of the hospital Hd is updated from “1” to “0.”

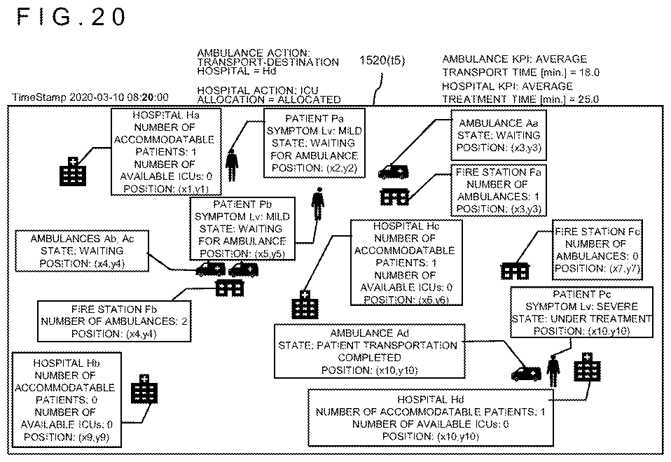

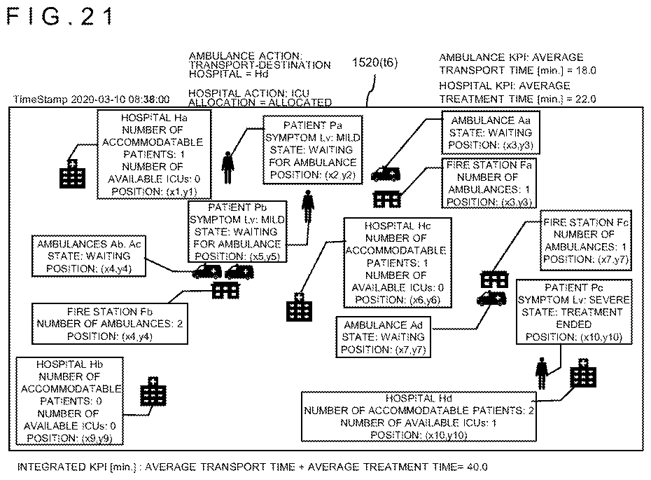

FIG. 20 is an explanatory diagram depicting an example 3 of pre-evaluation by the pre-evaluating section 1503. The pre-evaluation example 3 in FIG. 20 represents a shared internal state 1520(t5) in a case where an observation date/time t5 is Mar. 10, 2020, 8:20, which is ten minutes after the observation date/time t2. The shared internal state 1520(t5) represents a state where, according to the state observation data 132 at the observation date/time t5, the ambulance Ad onto which the patient Pc is carried at the position (x8, y8) transports the patient Pc to and arrives at the transport-destination hospital Pd.

In addition, since the ambulance Ad has arrived at the transport-destination hospital Hd, the state and position of the ambulance Ad are updated from “transporting patient” to “patient transportation completed” and to the same position (x10, x10) as the transport-destination hospital Hd, respectively, at the observation date/time t5. In addition, since the patient Pc also has arrived at the transport-destination hospital Hd, the state and position of the patient Pc are updated from “being transported” to “transportation completed” and to the same position (x10, x10) as the transport-destination hospital Hd, respectively, at the observation date/time t5.

Using, as transport time, a length of time from the date/time t1 when the ambulance Ad is dispatched from the fire station Fc until the date/time t5 when the ambulance Ad arrives at the transport-destination hospital Hd, the simulator 101A of the ambulance system 100A recomputes the average transport time, which is an ambulance KPI, and updates the average transport time from 17.0 [minutes] to 18.0 [minutes].

FIG. 21 is an explanatory diagram depicting an example 4 of pre-evaluation by the pre-evaluating section 1503. The pre-evaluation example 4 in FIG. 21 represents a shared internal state 1520(t6) in a case where an observation date/time t6 is Mar. 10, 2020, 8:38, which is 18 minutes after the observation date/time t5. The shared internal state 1520(t6) represents a state where, according to the state observation data 132 at the observation date/time t5, treatment of the patient Pc is ended at the transport-destination hospital Hd.

In addition, since the treatment of the patient Pc has been ended, the state of the patient Pc is updated from “under treatment” to “treatment ended,” the number of accommodatable patients of the hospital Hd is updated from “1” to “2,” and the number of available ICUs of the hospital Hd is updated from “0” to “1.”

Using, as treatment time, a length of time from the observation date/time t5 when the treatment of the patient Pc is started at the transport-destination hospital Hd until the observation date/time t6 when the treatment is ended, the simulator 101B of the hospital system 100B recomputes the average treatment time, which is a hospital KPI, and updates the average treatment time from 25.0 [minutes] to 22.0 [minutes].

FIG. 22 is an explanatory diagram depicting an example of the shared internal state 1520 of the simulators 101A and 101B in the pre-evaluation examples 1 to 3 in FIG. 18 to FIG. 21. The shared internal state 1520 is data formed by combining the internal states 111A and 111B.

FIG. 23 is an explanatory diagram depicting an example of the integrated action 1530 of the simulators 101A and 101B in the pre-evaluation examples 1 to 3 in FIG. 18 to FIG. 21. The integrated action 1530 is data formed by combining the actions 112A and 112B.

FIG. 24 is an explanatory diagram depicting an example of the pre-coordination integrated KPI computation result 1541 of the simulators 101A and 101B in the pre-evaluation examples 1 to 3 in FIG. 18 to FIG. 21. The pre-coordination integrated KPI computation result 1541 is the sum of the average transport time (ambulance KPI) of the ambulance system 100A and the average treatment time (hospital KPI) of the hospital system 100B before coordination of the ambulance system 10A and the hospital system 100B.

FIG. 25 is an explanatory diagram depicting an example of the post-coordination integrated KPI computation result 1542 of the simulators 101A and 101B in the pre-evaluation examples 1 to 3 in FIG. 18 to FIG. 21. The post-coordination integrated KPI computation result 1542 is the sum of the average transport time (ambulance KPI) of the ambulance system 100A and the average treatment time (hospital KPI) of the hospital system 100B after coordination of the ambulance system 100A and the hospital system 100B.

FIG. 26 is an explanatory diagram depicting an example of the post-coordination KPI computation result 1540A of the simulator 101A of the ambulance system 100A in the pre-evaluation examples 1 to 3 in FIG. 18 to FIG. 21. FIG. 27 is an explanatory diagram depicting an example of the post-coordination KPI computation result 1540B of the simulator 101B of the hospital system 100B in the pre-evaluation examples 1 to 3 in FIG. 18 to FIG. 21. The post-coordination integrated KPI computation result 1542 is the sum of the post-coordination KPI computation result 1540A and the post-coordination KPI computation result 1540B.

FIG. 28 is an explanatory diagram depicting an example of the integrated KPI list 1510. For each item number 2801, the integrated KPI list 1510 has a set 2802 of discrete systems 100, and an integrated KPI computation formula 2803. The item number 2801 is a number for identifying the set 2802 of discrete systems 100, and the integrated KPI computation formula 2803.

The set 2802 of discrete systems 100 specifies a plurality of coordination-subject discrete systems 100. The integrated KPI computation formula 2803 is a computation formula for calculating an integrated KPI by using a KPI output from each discrete system 100 in the set 2802 of discrete systems 100. For example, in the entry with the value of the item number 2801 which is “1,” the set 2802 of discrete systems 100 is A and B, and the integrated KPI computation formula 2803 is A+B.

That is, A+B means addition of the ambulance KPI from the ambulance system 100A and the hospital KPI from the hospital system 100B. In a case where the integrated KPI is calculated, the pre-evaluating section 1503 applies the integrated KPI computation formula 2803 corresponding to the set 2802 of coordinated discrete systems 100, and calculates the integrated KPI (the pre-coordination integrated KPI computation result 1541, the post-coordination integrated KPI computation result 1542).

FIG. 29 is an explanatory diagram depicting an example of the system coordination comparison perspective 1550. The system coordination comparison perspective 1550 represents an example of a determination process by the determining section 1507. (1) is a determination condition representing that it is determined that the integrated system after coordination is not good (the integrated system is not favorable) if kpi_b′ is worse than kpi_b. (2) is a determination condition representing that it is determined that the integrated system resulting from coordination of the ambulance system 100A and the hospital system 100B is okay (the integrated system is favorable) if kpi_superior′ is better than kpi_superior, and additionally kpi_b′ is better than kpi_b.

(3) is a determination condition representing that it is determined that the integrated system resulting from coordination of the ambulance system 100A and the hospital system 100B is not good (the integrated system is not favorable) if none of (1) and (2) described above are satisfied. Note that the determination conditions (1) to (3) are an example, and different determination conditions may be adopted. In addition, a system coordination comparison perspective 1550 may be set for each set 2802 of discrete systems 100.

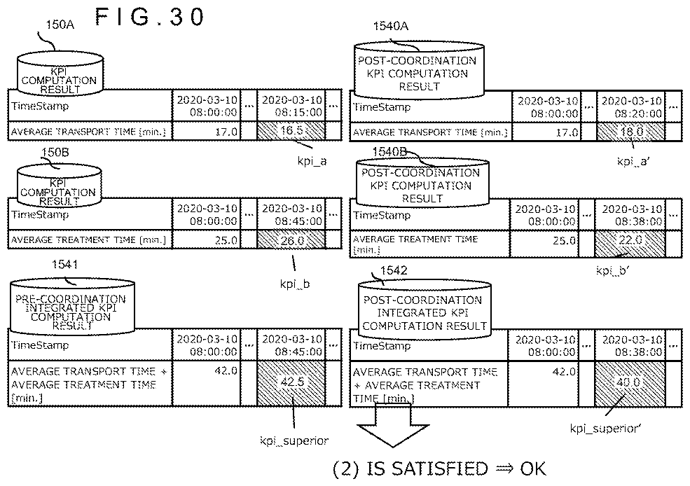

FIG. 30 is an explanatory diagram depicting an example of a determination process by the determining section 1507. Here, the average transport time 16.5 minutes, which is a value in the KPI computation result 150A, is used as kpi_a. The average transport time 18.0 minutes, which is a value in the post-coordination KPI computation result 1540A, is used as kpi_a′. The average transport time 26.0 minutes, which is a value in the KPI computation result 150B, is used as kpi_b. The average transport time 22.0 minutes, which is a value in the post-coordination KPI computation result 1540B, is used as kpi_b′. A value ((average transport time)+(average treatment time)) 42.5 minutes in the pre-coordination integrated KPI computation result 1541 is used as kpi_superior. A value ((average transport time)+(average treatment time)) 40.0 minutes in the post-coordination integrated KPI computation result 1501542 is used as kpi_superior′.

Since kpi_b is the average transport time 26.0 minutes, and kpi_b′ is the average transport time 22.0 minutes, the determination condition (1) is not satisfied. On the other hand, since kpi_superior′ is 40.0 minutes, and kpi_superior is 42.5 minutes, the determination condition (2) is satisfied. Accordingly, the determining section 1507 determines that the integrated system resulting from coordination of the ambulance system 100A and the hospital system 100B is favorable.

<Coordination Process Procedure Example>

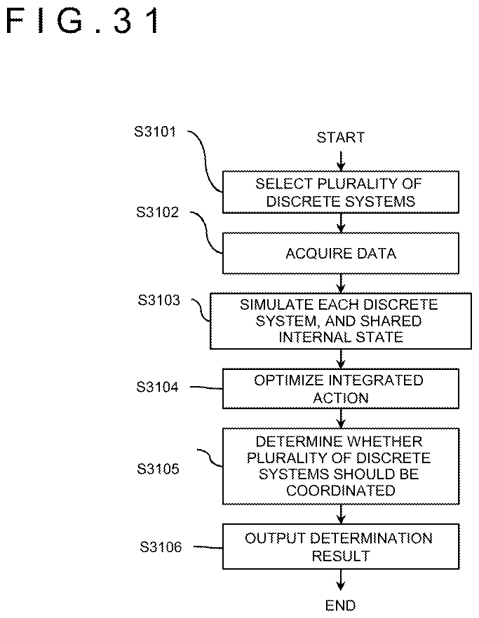

FIG. 31 is a flowchart depicting an example of a process procedure of coordinating a plurality of discrete systems 100 by the coordinating apparatus 1501 according to the first embodiment. The coordinating apparatus 1501 selects a plurality of discrete systems (e.g. the ambulance system 100A and the hospital system 100B) by using the selecting section 1502 (Step S3101), and acquires state observation data 132A and 132B input to the selected discrete systems 100A and 100B (Step S3102).

Next, the coordinating apparatus 1501 simulates each of the discrete systems 100A and 100B by using the simulator 101A or 101B, and generates the shared internal state 1520 by using the state sharing section 1504 (Step S3103).

Then, the coordinating apparatus 1501, by using the integrated action optimizing section 1506, integrates the actions 112A and 112B that can be adopted by the discrete systems 100A and 100B by using the action integrating section 1505, and generates and optimizes the integrated action 1530 (Step S3104). Specifically, for example, the coordinating apparatus 1501 refers to the integrated KPI list 1510, computes various types of KPI regarding the plurality of coordinated discrete systems 100A and 100B, and outputs the KPIs as the post-coordination KPI computation results 1540A and 1540B, the pre-coordination integrated KPI computation result 1541, and the post-coordination integrated KPI computation result 1542. The integrated action optimizing section 1506 decides the optimum actions 160A and 160B for the internal state 111 at a certain observation date/time from the actions 112A and 112B that can be adopted by the simulators 101A and 101B, such that the post-coordination integrated KPI computation result 1542 is maximized.

Thereafter, by using the post-coordination KPI computation results 1540A and 1540B, the pre-coordination integrated KPI computation result 1541, and the post-coordination integrated KPI computation result 1542, the coordinating apparatus 1501 determines whether or not the plurality of discrete systems 100A and 100B should be coordinated (Step S3105), and outputs a determination result (Step S3106).

<Example of Operation by Integrated System after Coordination>

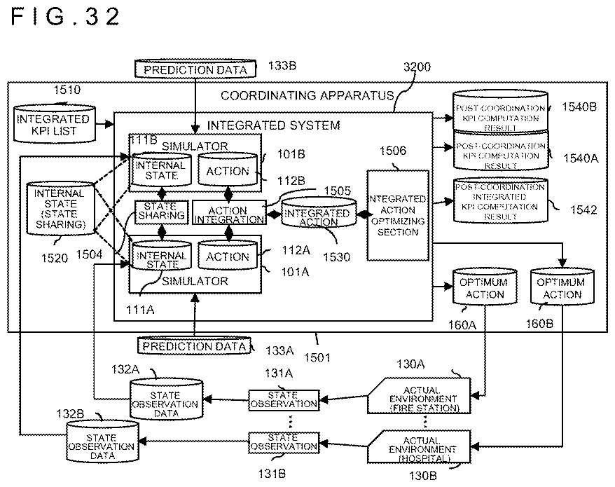

FIG. 32 is a block diagram depicting an example of operation by an integrated system after coordination. In a case where the determining section 1507 determines that discrete systems should be coordinated, an integrated system 3200 resulting from coordination of the ambulance system 100A and the hospital system 100B is generated. The integrated system 3200 after coordination operates the ambulance system 100A and the hospital system 100B as depicted in FIG. 18 to FIG. 21.

The integrated system 3200 has the simulators 101A and 101B, the state sharing section 1504, the action integrating section 1505, and the integrated action optimizing section 1506. The integrated system 3200 inputs state observation data 132A and 132B (or prediction data 133A and 133B) obtained through state observation 131A and 131B in actual environments 130A and 130B to the simulators 101A and 101B, respectively, and executes Steps S3103 and S3104 in FIG. 31. Thereby, the integrated system 3200 outputs the post-coordination KPI computation result 1540A of the ambulance system 100A, the post-coordination KPI computation result 1540B of the hospital system 100B, the post-coordination integrated KPI computation result 1542, the optimum action 160A of the ambulance system 100A, and the optimum action 160B of the hospital system 100B.

The optimum action 160A of the ambulance system 100A and the optimum action 160B of the hospital system 100B are used in the actual environments 130A and 130B, respectively. Then, the integrated system 3200 inputs, to the integrated system 3200, the state observation data 132A and 132B obtained through the state observation 131A and 131B in the actual environments 130A and 130B again, and continues the process. Thereby, after coordination, the integrated system 3200 performs operation, and interaction of the plurality of mutually coordinated simulators 101 in the integrated system 3200 is automated.

In this manner, according to the first embodiment, due to coordination of a plurality of discrete systems 100, the post-coordination integrated KPI computation result 1542 that is improved over the pre-coordination integrated KPI computation result 1541 obtained from an ambulance KPI or a hospital KPI of each single discrete system 100 can be obtained. Accordingly, it is possible to attempt to improve KPIs that could not have been realized with individual discrete systems 100.

### Second Embodiment

A second embodiment is different from the first embodiment in that the integrated system 3200 is generated automatically to thereby automate interaction of a plurality of mutually coordinated simulators 101 in the integrated system 3200. Here, explanations are given mainly about the second embodiment, and therefore explanations of contents that overlap those about the first embodiment are omitted.

The integrated system 3200 depicted in FIG. 32 imitates the behavior of discrete systems 100 after coordination, and therefore needs to reproduce interaction of the behavior of the discrete systems 100. If interaction of the behavior of discrete systems 100 is manually developed separately for each set 2802 of discrete systems 100, it takes time and manual efforts. Here, a configuration example of each of mutually coordinated discrete systems 100 (e.g. the ambulance system 100A and the hospital system 100B) is depicted.

<Configuration Example of Ambulance System 100A>

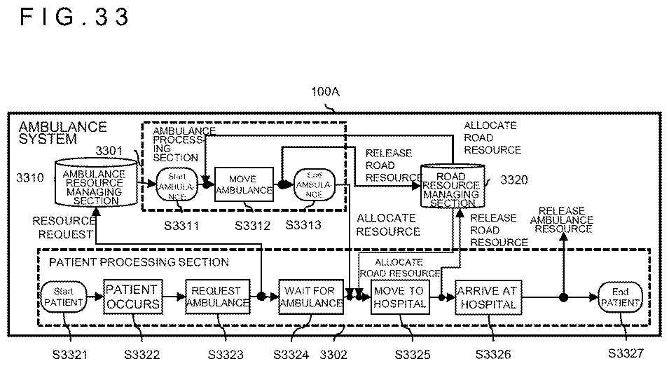

FIG. 33 is a block diagram depicting a configuration example of the ambulance system 100A. The ambulance system 100A has an ambulance processing section 3301, a patient processing section 3302, an ambulance resource managing section 3310, and a road resource managing section 3320. The ambulance resource managing section 3310 manages ambulance resources. The ambulance system 100A having the ambulance processing section 3301, the ambulance resource managing section 3310, and the road resource managing section 3320 makes it possible to attempt to reduce the development cost of the ambulance system 100A.

Here, the ambulance resources are information representing: how many ambulances A are waiting at each fire station F, and how many ambulances A have been dispatched from each fire station F (the number of ambulances A waiting at each fire station F, and the number of ambulances A that have been dispatched from each fire station F); where ambulances A are (the current positions of ambulances A); which fire station F has received a dispatch request for an ambulance A (whether or not each fire station F has received a dispatch request, and the position of a dispatch requester (patient P)); and the position of each hospital H.

The road resource managing section 3320 manages road resources. The road resources are a road network including links representing roads and nodes connecting the roads, and can represent the degree of congestion of vehicles of each link that changes over time.

The ambulance processing section 3301 refers to the ambulance resource managing section 3310, and, in a case where a fire station F received a dispatch request for an ambulance A, starts ambulance processing (Step S3311). At this time, the road resource managing section 3320 searches for a route that allows arrival at the dispatch requester in the shortest time, and allocates the route to the ambulance processing section 3301 as a road resource. The ambulance processing section 3301 causes an ambulance A to move to the dispatch requester according to the searched route (Step S3312), and, upon arrival at the dispatch requester, ends the ambulance processing, and releases the road resource (Step S3312).

In addition, upon receiving the state observation data 132A or the prediction data 133A, the patient processing section 3302 starts patient processing (Step S3321). The patient processing section 3302 detects an occurrence of a patient P from the state observation data 132A or the prediction data 133A (Step S3322), and makes a dispatch request for an ambulance A to a fire station F specified by the state observation data 132A or the prediction data 133A (which may be a fire station F closest to the patient P) (Step S3323).

The patient processing section 3302 keeps the dispatch-requester patient P waiting (Step S3324), and upon arrival of an ambulance A at the position of the dispatch-requester patient P as a result of a process by the ambulance processing section 3301 (Step S3313), the road resource managing section 3320 searches for a route that allows arrival at the hospital H from the dispatch requester in the shortest time, and allocates the route to the patient processing section 3302 as a road resource.

The patient processing section 3302 transports the patient P to the transport-destination hospital H, according to the route allocated as the road resource by the road resource managing section 3320 (Step S3325), and, upon arrival at the hospital H (Step S3326), releases the road resource and the ambulance resource, and ends the patient processing (Step S3327).

<Configuration Example of Hospital System 100B>

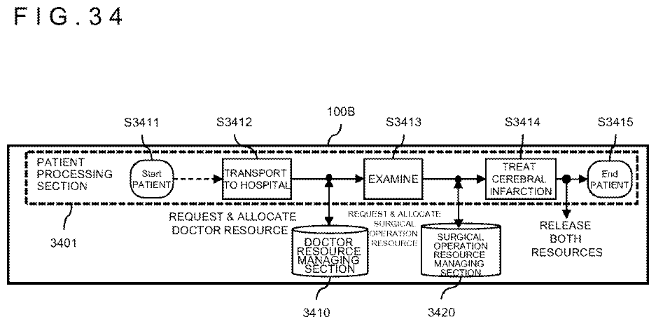

FIG. 34 is a block diagram depicting a configuration example of the hospital system 100B. There is a hospital system 100B for each hospital H, and the hospital system 100B has a hospital processing section 3401, a doctor resource managing section 3410, and a treatment room resource managing section 3420. The hospital system 100B having the hospital processing section 3401, the doctor resource managing section 3410, and the treatment room resource managing section 3420 makes it possible to attempt to reduce the development cost of the hospital system 100B.

Here, the doctor resource managing section 3410 manages, as doctor resources, attendance and absence of doctors as to which doctor is attending to which task, and so on. The treatment room resource managing section 3420 manages the availability of processing rooms (surgical operation rooms and ICUs) as treatment room resources.

The hospital processing section 3401, upon receiving state observation data 132B or prediction data 133B, starts hospital processing (Step S3411). Then, upon detecting that the patient P has been carried into the hospital H on the basis of the state observation data 132B or the prediction data 133B including a symptom level (Step S3412), the hospital processing section 3401 requests the doctor resource managing section 3410 to allocate a doctor resource, and the doctor resource managing section 3410 allocates a waiting doctor as a doctor resource.

The hospital processing section 3401 causes the allocated doctor to examine the patient P (Step S3413), and requests the treatment room resource managing section 3420 to allocate a treatment room resource according to an examination result (which may be set in the state observation data 132B or the prediction data 133B in advance; it is supposed here that the patient P is diagnosed with “cerebral infarction” as an example). The treatment room resource managing section 3420 allocates, as a treatment room resource, a surgical operation room or an ICU according to the examination result and the availability. The hospital processing section 3401 treats cerebral infarction by using the doctor resource and the treatment room resource (Step S3414), releases the doctor resource and the treatment room resource after the treatment is ended, and ends the hospital processing (Step S3415).

<Connection Example of Discrete System 100>

Taking, as an example of interaction of the behavior of the ambulance system 100A and the hospital system 100B, a procedure of a series of processes in which a patient P is transported to a hospital H by an ambulance A, and thereafter treatment at the hospital H is started, the number of patients transported to the transport-destination hospital H in the ambulance system 100A, and the number of patients treated at the hospital H in the hospital system 100B match. Because of this, by synchronizing the ambulance system 100A and the hospital system 100B, it becomes possible to make a transition from an end of the hospital processing of the ambulance system 100A to a start of the hospital processing of the hospital system 100B.

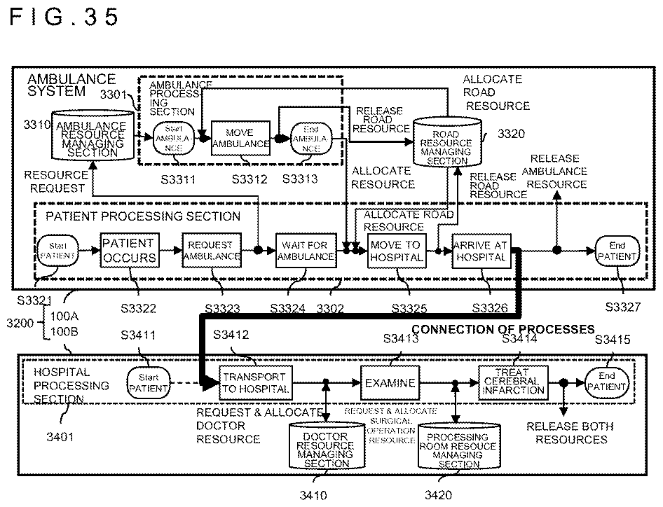

FIG. 35 is a block diagram depicting a connection example 1 of discrete systems 100 in the integrated system 3200. FIG. 35 depicts an example of connection between the ambulance system 100A and the hospital system 100B. In the integrated system 3200, hospital arrival in the patient processing section 3302 of the ambulance system 100A (Step S3326), and hospital transportation in the hospital processing of the hospital system 100B (Step S3412) are connected with each other. That is, the hospital transportation (Step S3412) is set as the transition destination of the hospital arrival (Step S3326). Thereby, the patient P having arrived at the hospital H in the ambulance system 100A results in being directly processed in the hospital system 100B, and there is mutual influence of timings of processes and quantities related to the processes.

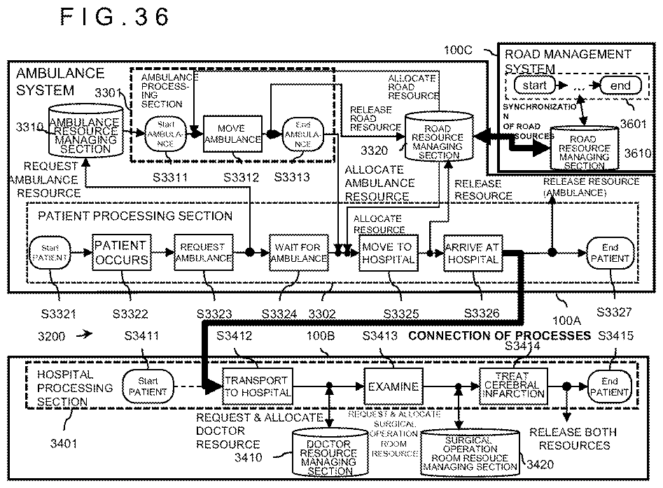

FIG. 36 is a block diagram depicting a connection example 2 of discrete systems 100 in the integrated system 3200. This connection example 2 depicts the integrated system 3200 in which a road management system 1000 is coordinated, in addition to the ambulance system 100A and the hospital system 100B. The road management system 100C is a system that manages roads, and specifically, has a road processing section 3601 and a road resource managing section 3610, for example.

The road resource managing section 3610 manages road resources, similarly to the road resource managing section 3320. It is supposed here that the road resources managed by the road resource managing section 3610 cover the road resources (road network) managed by the road resource managing section 3320. The road processing section 3601 executes road management by using the road resources. The road management includes managing vehicle travelling positions and travelling speeds, signaling colors of traffic lights, and the like, executing prediction of traffic jams by setting the degrees of congestion of links in the road network, searching for a route from a point of departure to a target point by using the degrees of congestion, and so on.

Since the ambulance system 100A and the road management system 100C are coordinated in the integrated system 3200 in FIG. 36, the road resources of the road resource managing sections 3610 and 3320 are synchronized. That is, if, in the road resource managing section 3610, the degree of congestion of a link in a range of road resources that is common to the road resource managing sections 3610 and 3320 is updated, the degree of congestion of the link is updated synchronously also in the road resources managed by the road resource managing section 3320.

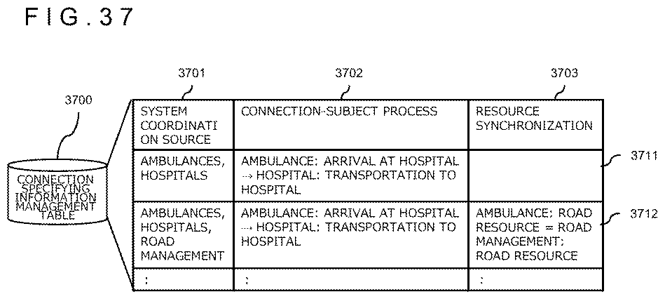

FIG. 37 is an explanatory diagram depicting an example of a connection specifying information management table. A connection specifying information management table 3700 is a table for managing information (connection specifying information) specifying connection between simulators 101 of discrete systems 100. The connection specifying information management table 3700 is information stored on the coordinating apparatus 1501, and can be set or changed by a user. As its fields, the connection specifying information management table 3700 has system coordination sources 3701, connection-subject processes 3702, and resource synchronization 3703, and a set of values in respective fields in the same row form an entry representing one piece of connection specifying information.

The system coordination sources 3701 specifies a plurality of coordination-source discrete systems 100. In an entry 3711, the ambulance system 100A and the hospital system 100B are specified, and in an entry 3712, the ambulance system 100A, the hospital system 100B, and the road management system 100C are set.

The connection-subject processes 3702 each specify a transition source process and a transition destination process that are connected with each other between system-coordination-source discrete systems 100. In the entries 3711 and 3712, hospital arrival of the patient processing section 3302 of the ambulance system 100A (Step S3326) is specified as a transition source process, and hospital transportation of the hospital processing section 3401 of the hospital system 100B (Step S3412) is specified as a transition destination process.

The resource synchronization 3703 specifies resources to be synchronized between the system-coordination-source discrete systems 100. In the entry 3711, the resource synchronization 3703 is blank since there are no resources to be synchronized. In the entry 3712, a road resource managed by the road resource managing section 3320 of the ambulance system 100A, and a road resource managed by the road processing section 3601 of the road management system 100C are specified as resources to be synchronized.

As depicted in FIG. 35, the entry 3711 is connection specifying information specified by the coordinating apparatus 1501 when the ambulance system 100A and the hospital system 100B are coordinated to generate the integrated system 3200. Thereby, as depicted in FIG. 35, hospital arrival of the patient processing section 3302 of the ambulance system 100A (Step S3326) is connected to hospital transportation of the hospital processing section 3401 of the hospital system 100B (Step S3412) to generate the integrated system 3200.

As depicted in FIG. 36, the entry 3712 is connection specifying information specified by the coordinating apparatus 1501 when the ambulance system 100A, the hospital system 100B, and the road management system 100C are coordinated to generate the integrated system 3200. Thereby, as depicted in FIG. 36, connection is established such that a transition is made from hospital arrival of the patient processing section 3302 of the ambulance system 100A (Step S3326) to hospital transportation of the hospital processing section 3401 of the hospital system 100B (Step S3412), and a road resource managed by the road resource managing section 3320 of the ambulance system 100A, and a road resource managed by the road processing section 3601 of the road management system 100C are synchronized to generate the integrated system 3200.

<Coordination Process Procedure Example>

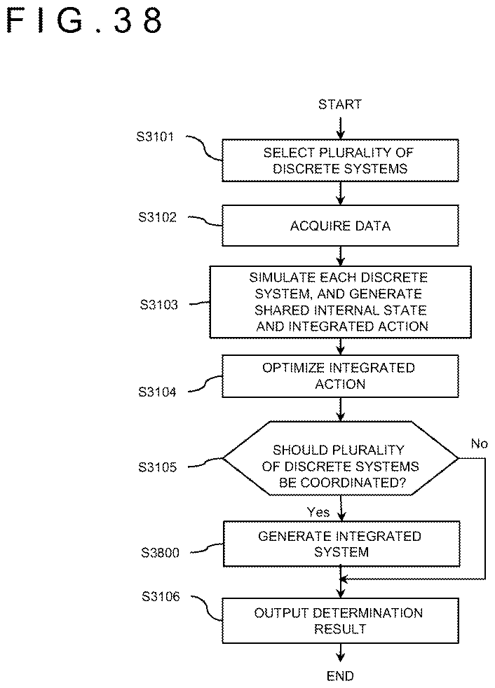

FIG. 38 is a flowchart depicting an example of a process procedure of coordinating a plurality of discrete systems 100 by the coordinating apparatus 1501 according to the second embodiment. Explanations of processes that overlap those about FIG. 31 are omitted. By using the post-coordination KPI computation results 1540A and 1540B, the pre-coordination integrated KPI computation result 1541, and the post-coordination integrated KPI computation result 1542, the coordinating apparatus 1501 determines whether or not the plurality of discrete systems 100A and 100B should be coordinated (Step S3105).

In a case where it is determined that the plurality of discrete systems 100A and 100B should be coordinated (Step S3105: Yes), the coordinating apparatus 1501 selects connection specifying information (e.g. the entry 3711 or 3712) from the connection specifying information management table 3700, generates the integrated system 3200 in FIG. 32 (Step S3800), and outputs a result of the determination (Step S3106). On the other hand, in a case where it is determined that the plurality of discrete systems 100A and 100B should not be coordinated (Step S3105: No), the coordinating apparatus 1501 outputs the determination result (Step S3106). Note that in a case where it is determined that the plurality of discrete systems 100A and 100B should be coordinated (Step S3105: Yes), prior to generation of the integrated system 3200 (Step S3800), the coordinating apparatus 1501 may output the determination result (Step S3106). In this case, a user may refer to the determination result, and decide whether or not generation of the integrated system 3200 (Step S3800) should be executed.

In this manner, by connection between hospital arrival of the ambulance system 100A (Step S3326) and hospital transportation of the hospital system 100B (Step S3412), and synchronization between road resources of the road resource managing sections 3320 and 3610, interaction between the ambulance system 100A and the hospital system 100B can be reproduced. Accordingly, due to such interface settings, man-hours required for development by simulation of integration by coordination are reduced.

### Third Embodiment

A third embodiment depicts an example in which coordination between discrete systems 100 is tested efficiently. As the number of discrete systems 100 increases, the number of sets 2802 of discrete systems 100 to be coordinated becomes enormous, and the coordinating apparatus 1501 cannot evaluate advantages of coordination among discrete systems 100 in a practical length of computation time. For example, even in a case where coordination among five or less than five discrete systems 100 from a mere ten discrete systems 100 is considered, the number N of sets 2802 of discrete systems 100 to be coordinated is enormous as represented by the following Formula (1).

$$[ Formula 1 ]$$

$$N = {\sum }_{i = 2 - S} {}_{10} {C}_{i} = 627 \qquad ( 1 )$$

Accordingly, the third embodiment is different from the first embodiment and the second embodiment in that each discrete system 100 monitors KPIs and the like over time before a plurality of discrete systems 100 are coordinated, and requests the coordinating apparatus 1501 to coordinate discrete systems 100 including itself according to results of the monitoring.

That is, for example, when a discrete system 100 whose KPI does not reach a target makes a coordination request to the coordinating apparatus 1501, the coordinating apparatus 1501 tests coordination between the discrete system 100 and other discrete systems 100. Thereby, it becomes unnecessary to test coordination of all patterns of sets of the group 100s of discrete systems. Accordingly, it is possible to attempt to make coordination between discrete systems 100 efficient, and evaluation of coordination between discrete systems 100 is realized in a practical length of time. Note that, here, explanations are given mainly about the third embodiment, and therefore explanations of contents that overlap those about the first embodiment and the second embodiment are omitted.

<Discrete System 100>

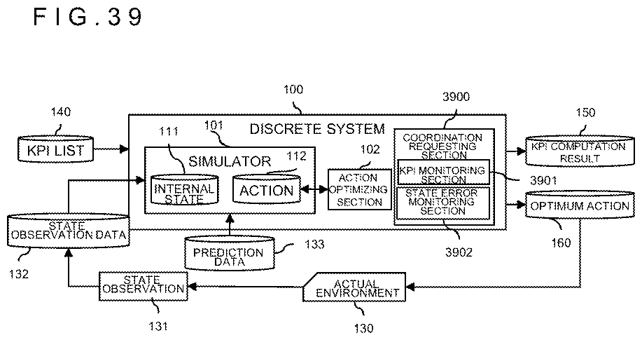

FIG. 39 is a block diagram depicting a configuration example of discrete systems 100 according to the third embodiment. The discrete system 100 has a coordination requesting section 3900. Specifically, for example, the coordination requesting section 3900 is realized by causing the processor 1701 to execute a program stored on the storage device 1702. The coordination requesting section 3900 has a KPI monitoring section 3901 and a state error monitoring section 3902.

The KPI monitoring section 3901 monitors temporal changes in a KPI output as the KPI computation result 150. The state error monitoring section 3902 compares the internal state 111 generated by the simulator 101 of the discrete system 100, and the state observation data 132 collected from the actual environment 130 through the state observation 131 with each other, and monitors errors therebetween. In a case where the KPI or a state error has not reached a target value for a predetermined period or has deteriorated significantly, the coordination requesting section 3900 transmits a coordination request to the selecting section 1502 of the coordinating apparatus 1501.

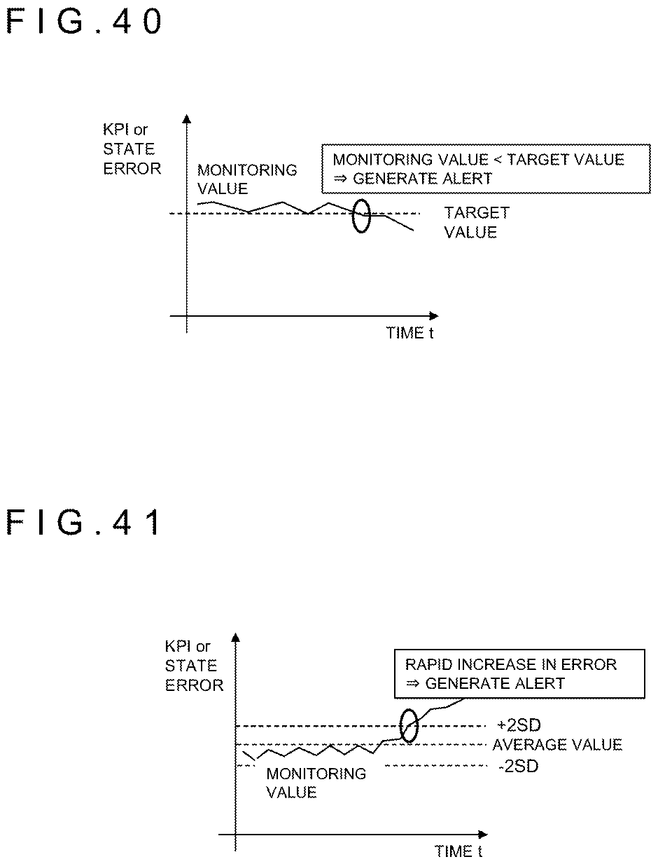

FIG. 40 is a graph depicting an example 1 of monitoring by the KPI monitoring section 3901 and the state error monitoring section 3902. FIG. 41 is a graph depicting an example 2 of monitoring by the KPI monitoring section 3901 and the state error monitoring section 3902. A monitoring value is the value of the KPI or state error. The state error monitoring section 3902 calculates, as a state error, the distance between the numeric vector of the internal state 111 and the numeric vector of the state observation data 132 or the similarity between the numeric vectors, for example. The higher the similarity between the internal state 111 and the state observation data 132 is, the smaller the state error is.

In FIG. 40, the KPI monitoring section 3901 generates an alert if the KPI falls below the target value. Similarly, the state error monitoring section 3902 generates an alert if the state error falls below the target value.

In FIG. 41, if the value of the standard deviation of past time-series changes in the monitoring value is SD, for example, the average value±2SD of the past time-series changes in the monitoring value is set as a tolerance range of the monitoring value. The KPI monitoring section 3901 generates an alert if the KPI is outside the tolerance range. Similarly, the state error monitoring section 3902 generates an alert if the state error is outside the tolerance range.

The coordination requesting section 3900 may transmit a coordination request to the selecting section 1502 of the coordinating apparatus 1501 in a case where an alert is generated from the KPI monitoring section 3901, may transmit a coordination request to the selecting section 1502 of the coordinating apparatus 1501 in a case where an alert is generated from the state monitoring section, or may transmit a coordination request to the selecting section 1502 of the coordinating apparatus 1501 in a case where alerts are generated from the KPI monitoring section 3901 and the state monitoring section. Alert generation conditions under which coordination requests are transmitted are set in advance.

<Examples of Coordination-Subject Selection>

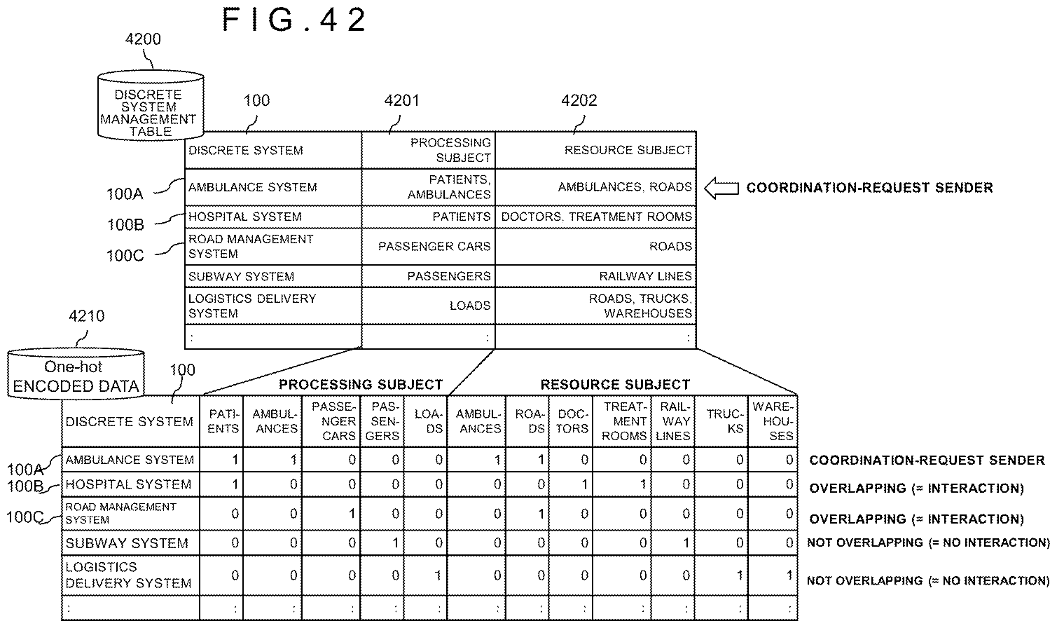

FIG. 42 is an explanatory diagram depicting an example of coordination-subject selection by the selecting section 1502 according to the third embodiment. The selecting section 1502 has a discrete system management table 4200, and generates One-hot encoded data 4210 about a coordination request sender. The discrete system management table 4200 is a table for managing selection-subject discrete systems 100. In the discrete system management table 4200, for each discrete system 100, processing subjects 4201 on which the discrete system 100 executes processes, and resource subjects (resource subjects) 4202 managed by the discrete system 100 are managed.

For example, in a case where the discrete system 100 is the ambulance system 100A, the processing subjects 4201 are ambulances of the ambulance processing section 3301 and patients of the patient processing section 3302, and the resource subjects 4202 are ambulances which are the subject of ambulance resources managed by the ambulance resource managing section 3310, and roads which are the subject of road resources managed by the road resource managing section 3320.

It is supposed that the ambulance system 100A is a coordination request sender in FIG. 42. The selecting section 1502 generates the One-hot encoded data 4210 about the ambulance system 100A as the coordination request sender. The One-hot encoded data 4210 is a One-hot vector generated by encoding processing subjects and resource subjects as “1,” and subjects other than them as “0,” for each discrete system 100.

In a case of the ambulance system 100A as the coordination request sender, “1” is set for “patients” and “ambulances,” which are the processing subjects 4201, and “0” is set for the other processing subjects 4201. In addition, “1” is set for “ambulances” and “roads,” which are the resource subjects 4202, and “0” is set for the other resource subjects 4202.

Regarding each of the other discrete systems 100 also than the discrete systems 100 as the coordination request sender, “1” is set for the processing subjects 4201, and “0” is set for the other processing subjects 4201. In addition, “1” is set for the resource subjects 4202, and “0” is set for the other resource subjects 4202.

The selecting section 1502 selects, as a candidate to be coordinated with the coordination request sender, another discrete system 100 having at least one processing subject 4201 or resource subject 4202 which is also a processing subject 4201 or resource subject 4202 of the coordination request sender. For example, discrete systems 100 for which “1” is set for “patients” as their processing subjects 4201 in the One-hot encoded data 4210 are the ambulance system 100A and the hospital system 100B. Accordingly, the selecting section 1502 selects the hospital system 100B as a candidate to be coordinated with the ambulance system 100A.

In addition, discrete systems 100 for which “1” is set for “roads” as their resource subjects 4202 are the ambulance system 100A and the road management system 100C. Accordingly, the selecting section 1502 selects the road management system 100C as a candidate to be coordinated with the ambulance system 100A. Since, regarding a subway system and a logistics delivery system, “0” is set for both “patients” and “ambulances” as their processing subjects 4201 and “roads” as their resource subjects 4202,” the selecting section 1502 does not select the subway system and the logistics delivery system as candidates to be coordinated with the ambulance system 100A.

In addition, the selecting section 1502 may calculate the distance between a One-hot vector of a coordination-request-sender discrete system 100 (the ambulance system 100A), and a One-hot vector of a second discrete system 100 in the One-hot encoded data 4210, and, if the calculated distance is equal to or shorter than a threshold value, may select the second discrete system 100 as a coordination candidate. In addition, the selecting section 1502 may select a predetermined number of other discrete systems 100 in ascending order of calculated distances.

In this manner, according to the third embodiment, candidates of coordination among discrete systems 100 are narrowed without testing coordination of all sets of discrete systems 100, and thereby the coordinating apparatus 1501 can realize evaluation of coordination among discrete systems 100 in a practical length of time. In addition, although the One-hot encoded data 4210 includes One-hot vectors of processing subjects 4201 and One-hot vectors of resource subjects 4202, it is sufficient if at least one type of One-hot vector is included.

In addition, after generation of the One-hot encoded data 4210, an existing discrete system 100 is corrected or deleted, or a new discrete system 100 is added in some cases. Accordingly, regardless of a coordination request from a discrete system 100, the selecting section 1502 may regenerate the One-hot encoded data 4210, and select a discrete system 100 to be a coordination partner for each discrete system 100 by being triggered by a trigger event which is correction, deletion, addition, or an elapse of a predetermined length of time from the previous selection of a discrete system 100.

For example, in a case where the ambulance system 100A is corrected, the selecting section 1502 selects, along with the ambulance system 100A after being corrected, the hospital system 100B and the road management system 100C that had been coordinated before the correction, and regenerates the integrated system 3200.

In addition, in a case where the hospital system 100B is deleted, the selecting section 1502 selects the ambulance system 100A that had been coordinated with the hospital system 100B before the deletion, and the road management system 100C that had been coordinated with the ambulance system 100, and regenerates the integrated system 3200.

In addition, in a case where the road management system 100C is added to the group 100s of discrete systems, the selecting section 1502 selects the road management system 100C, also selects each discrete system 100 in the group 100s of discrete systems as a candidate to be coordinated with the road management system 100C, and generates the integrated system 3200.

Thereby, the coordinating apparatus 1501 can test coordination among discrete systems 100 on the basis of the discrete systems 100 in their latest states, and makes it possible to attempt to enhance the reliability of the integrated system 3200.

As explained above, according to the coordinating apparatus 1501 according to the first embodiment to the third embodiment mentioned above, coordination among a plurality of discrete systems 100 enables improvements of KPIs that could not have been improved with a discrete system 100 singly, and makes it possible to attempt to realize an overall optimization of the plurality of coordinated discrete systems 100.

In addition, the coordinating apparatus 1501 according to the first embodiment to the third embodiment mentioned above can also be configured as in (1) to (13) described below.

(1) The coordinating apparatus 1501 has the processor 1701 that executes a program, and the storage device 1702 that stores the program. The processor 1701 executes: a selection process (Step S3101) of selecting the plurality of discrete systems 100A and 100B from the group 100s of discrete systems each of which simulates the behavior of the actual environment 130, and outputs an indicator value (the KPI computation result 150) related to the actual environment 130; a decision process (Step S3104) of sharing each of the internal states 111A and 111B related to the actual environments 130A and 130B, each of the internal states 111A and 111B being obtained on the basis of the behavior simulated by each of the plurality of discrete systems 100A and 100B selected in the selection process (Step S3101), generating the shared internal state 1520 (Step S3103), and, on the basis of the shared internal state 1520, deciding such an action (the optimum actions 160A and 160B) that a post-coordination integrated indicator value (the post-coordination integrated KPI computation result 1542) obtained by integrating a post-coordination indicator value (the post-coordination KPI computation results 1540A and 1540B) from each of the plurality of discrete systems 100A and 100B in a case where the plurality of discrete systems 100A and 100B are coordinated is optimized, the action being should be taken and being able to be taken by each of the discrete systems 100A and 100B in a case where the plurality of discrete systems 100A and 100B are coordinated; a determination process (Step S3105) of determining whether or not the plurality of discrete systems 100A and 100B should be coordinated on the basis of the post-coordination indicator values (the post-coordination KPI computation results 1540A and 1540B), and an indicator value (the pre-coordination KPI computation results 1541A and 1541B) from each of the plurality of discrete systems 100A and 100B in a case where the plurality of discrete systems 100A and 100B are not coordinated; and an output process (Step S3106) of outputting a result of the determination in the determination process (Step S3105).
(2) In the coordinating apparatus 1501 according to (1) described above, in the determination process (Step S3105), the processor 1701 determines whether or not the plurality of discrete systems 100A and 100B should be coordinated on the basis of the post-coordination integrated indicator value (the post-coordination integrated KPI computation result 1542), and a pre-coordination integrated indicator value (the pre-coordination integrated KPI computation result 1541) obtained by integrating an indicator value (the pre-coordination KPI computation results 1541A and 1541B) from each of the plurality of discrete systems 100A and 100B.
(3) In the coordinating apparatus 1501 according to (1) described above, the processor 1701, in a case where it is determined in the determination process (Step S3105) that the plurality of discrete systems 100A and 100B should be coordinated (Step S3105: Yes), executes a generation process (Step S3106) of generating the integrated system 3200 formed by integrating the plurality of discrete systems 100A and 100B, such that a transition is made from a first process (S3326) in a first group of processes (S3321 to S3327) executed by the first discrete system 100A in the plurality of discrete systems 100A and 100B to a second process (S3412) in a second group of processes (S3411 to S3415) executed by the second discrete system 100B in the plurality of discrete systems 100A and 100B.
(4) In the coordinating apparatus 1501 according to (3) described above, in the generation process (Step S3106), the processor 1701 generates (Step 33106) the integrated system 3200 on the basis of information (the entry 3711) that the first process (S3326) of the first discrete system 100A is treated as a transition source process, and the second process (S3412) of the second discrete system 100B is treated as a transition destination process of the first process (S3326).
(5) In the coordinating apparatus 1501 according to (1) described above, the processor 1701, in a case where it is determined in the determination process (Step S3105) that the plurality of discrete systems should be coordinated (Step S3105: Yes), executes a generation process (Step S3106) of generating the integrated system 3200 formed by integrating the plurality of discrete systems 100A and 100C, by synchronizing a first resource (road resources of the road resource managing section 3320) used in a first group of processes executed by the first discrete system 100A in the plurality of discrete systems 100A and 100C, and a second resource (road resources of the road resource managing section 3610) that is used in a third group of processes (the road processing section 3601) executed by the third discrete system 100C in the plurality of discrete systems 100A and 100C and is of the same type as the first resource.
(6) In the coordinating apparatus 1501 according to (5) described above, in the generation process (Step S3106), the processor 1701 generates the integrated system 3200 on the basis of information (the entry 3712) that the first resource of the first discrete system 100A and the second resource of the third discrete system 100C are treated as synchronization subjects.
(7) In the coordinating apparatus 1501 according to (1) described above, in the selection process (Step S3101), the processor 1701, on the basis of a predetermined trigger event, selects the particular discrete system 100A that is included in the group 100s of discrete systems and that corresponds to the predetermined trigger event, and the second discrete system 100B other than the particular discrete system 100A.
(8) In the coordinating apparatus 1501 according to (7) described above, in the selection process (Step S3101), the processor 1701 selects the particular discrete system 100B and the second discrete system 100A by being triggered by the predetermined trigger event which is a coordination request from the particular discrete system 100B.
(9) In the coordinating apparatus 1501 according to (7) described above, in the selection process (Step S3101), the processor 1701 selects the corrected discrete system 100B and the second discrete system 100A other than the corrected discrete system 100B by being triggered by the predetermined trigger event which is correction of a discrete system 100A in the group 100s of discrete systems.
(10) In the coordinating apparatus 1501 according to (7) described above, in the selection process (Step S3101), the processor 1701 selects the coordinated discrete system 100A that had been coordinated with the deleted discrete system 100B and the second discrete system 100C other than the coordinated discrete system 100A by being triggered by the predetermined trigger event which is deletion of a discrete system 100B in the group 100s of discrete systems.
(11) In the coordinating apparatus 1501 according to (7) described above, in the selection process (Step S3101), the processor 1701 selects the new discrete system 100C and the second discrete system 100A other than the new discrete system 100C by being triggered by the predetermined trigger event which is addition of the new discrete system 100C to the group 100s of discrete systems.
(12) In the coordinating apparatus 1501 according to (7) described above, in the selection process (Step S3101), the processor 1701 selects the particular discrete system 100A and the second discrete system 100B other than the particular discrete system 100A on the basis of a commonality between the processing subject 4101 of a group of processes executed by the particular discrete system 100A, and the processing subject 4101 of a group of processes executed by the second discrete system 100B.
(13) In the coordinating apparatus 1501 according to (7) described above, in the selection process (Step 33101), the processor. 1701 selects the particular discrete system 100A and the second discrete system 100C other than the particular discrete system 100A on the basis of a commonality between the resource subject 4102 used by the particular discrete system 100A, and the resource subject 4102 used by the second discrete system 100C.

Note that the present invention is not limited to the embodiments mentioned before, but includes various modification examples and equivalent configuration within the gist of attached claims. For example, the embodiments mentioned before are explained in detail in order to explain the present invention in an easy-to-understand manner, and the present invention is not necessarily limited to embodiments including all the constituent elements explained. In addition, some of the constituent elements of an embodiment may be replaced with constituent elements of another embodiment. In addition, the constituent elements of an embodiment may additionally have constituent elements of another embodiment. In addition, some of the constituent elements of each embodiment may additionally have other constituent elements, be deleted, or be replaced with other constituent elements.

In addition, some or all of constituent elements, functionalities, processing sections, processing means, and the like mentioned before may be realized by hardware by, for example, designing them in an integrated circuit, and so on, or may be realized by software by a processor interpreting and executing a program to realize respective functionalities.

Information such as a program, a table, or a file to realize each functionality can be stored on a storage apparatus such as a memory, a hard disk, or an SSD (Solid State Drive) or a recording medium such as an IC (Integrated Circuit) card, an SD card, or a DVD (Digital Versatile Disc).

In addition, control lines and information lines that are considered to be necessary for explanation are depicted, and it is not always the case where all control lines and information lines required for implementation are depicted. Actually, it may be considered that almost all constituent elements are connected mutually.

1. A coordinating apparatus having a processor that executes a program, and a storage device that stores the program, wherein
the processor executes
a selection process of selecting a plurality of discrete systems from a group of discrete systems each of which simulates behavior of an actual environment, and outputs an indicator value related to the actual environment;
a decision process of sharing each of internal states related to the actual environments, each of the internal states being obtained on a basis of the behavior simulated by each of the plurality of discrete systems selected in the selection process, generating a shared internal state, and, on a basis of the shared internal state, deciding such an action that a post-coordination integrated indicator value obtained by integrating a post-coordination indicator value from each of the plurality of discrete systems in a case where the plurality of discrete systems are coordinated is optimized, the action being should be taken and being able to be taken by each of the discrete systems in a case where the plurality of discrete systems are coordinated;
a determination process of determining whether or not the plurality of discrete systems should be coordinated on a basis of the post-coordination indicator values, and the indicator value from each of the plurality of discrete systems; and
an output process of outputting a result of the determination in the determination process.

2. The coordinating apparatus according to claim 1, wherein,
in the determination process, the processor determines whether or not the plurality of discrete systems should be coordinated on a basis of the post-coordination integrated indicator value, and a pre-coordination integrated indicator value obtained by integrating the indicator value from each of the plurality of discrete systems.

3. The coordinating apparatus according to claim 1, wherein,
the processor,
in a case where it is determined in the determination process that the plurality of discrete systems should be coordinated,
executes a generation process of generating an integrated system formed by integrating the plurality of discrete systems, such that a transition is made from a first process in a first group of processes executed by a first discrete system in the plurality of discrete systems to a second process in a second group of processes executed by a second discrete system in the plurality of discrete systems.

4. The coordinating apparatus according to claim 3, wherein,
in the generation process, the processor generates the integrated system on a basis of information that the first process of the first discrete system is treated as a transition source process, and the second process of the second discrete system is treated as a transition destination process of the first process.

5. The coordinating apparatus according to claim 1, wherein,
the processor,
in a case where it is determined in the determination process that the plurality of discrete systems should be coordinated,
executes a generation process of generating an integrated system formed by integrating the plurality of discrete systems, by synchronizing a first resource used in a first group of processes executed by a first discrete system in the plurality of discrete systems, and a second resource that is used in a third group of processes executed by a third discrete system in the plurality of discrete systems and is of a same type as the first resource.

6. The coordinating apparatus according to claim 5, wherein,
in the generation process, the processor generates the integrated system on a basis of information that the first resource of the first discrete system and the second resource of the third discrete system are treated as synchronization subjects.

7. The coordinating apparatus according to claim 1, wherein,
in the selection process, the processor, on a basis of a predetermined trigger event, selects a particular discrete system that is included in the group of discrete systems and that corresponds to the predetermined trigger event, and a second discrete system other than the particular discrete system.

8. The coordinating apparatus according to claim 7, wherein,
in the selection process, the processor selects the particular discrete system and the second discrete system by being triggered by the predetermined trigger event which is a coordination request from the particular discrete system.

9. The coordinating apparatus according to claim 7, wherein,
in the selection process, the processor selects a corrected discrete system and a second discrete system other than the corrected discrete system by being triggered by the predetermined trigger event which is correction of any one of the discrete systems in the group of discrete systems.

10. The coordinating apparatus according to claim 7, wherein,
in the selection process, the processor selects a coordinated discrete system that had been coordinated with a deleted discrete system, and a second discrete system other than the coordinated discrete system by being triggered by the predetermined trigger event which is deletion of any one of the discrete systems in the group of discrete systems.

11. The coordinating apparatus according to claim 7, wherein,
in the selection process, the processor selects a new discrete system, and a second discrete system other than the new discrete system by being triggered by the predetermined trigger event which is addition of the new discrete system to the group of discrete systems.

12. The coordinating apparatus according to claim 7, wherein,
in the selection process, the processor selects the particular discrete system and the second discrete system on a basis of a commonality between a processing subject of a group of processes executed by the particular discrete system, and a processing subject of a group of processes executed by the second discrete system.

13. The coordinating apparatus according to claim 7, wherein,
in the selection process, the processor selects the particular discrete system and the second discrete system on a basis of a commonality between a subject of a resource used by the particular discrete system, and a subject of a resource used by the second discrete system.

14. A coordination method executed by a coordinating apparatus having a processor that executes a program, and a storage device that stores the program, the coordination method comprising:
by the processor,
executing a selection process of selecting a plurality of discrete systems from a group of discrete systems each of which simulates behavior of an actual environment, and outputs an indicator value related to the actual environment;
executing a decision process of sharing each of internal states related to the actual environments, each of the internal states being obtained on a basis of the behavior simulated by each of the plurality of discrete systems selected in the selection process, generating a shared internal state, and, on a basis of the shared internal state, deciding such an action that a post-coordination integrated indicator value obtained by integrating a post-coordination indicator value from each of the plurality of discrete systems in a case where the plurality of discrete systems are coordinated is optimized, the action being should be taken and being able to be taken by each of the discrete systems in a case where the plurality of discrete systems are coordinated;
executing a determination process of determining whether or not the plurality of discrete systems should be coordinated on a basis of the post-coordination indicator values, and the indicator value from each of the plurality of discrete systems; and
executing an output process of outputting a result of the determination in the determination process.
